(19) United States
(12) Patent Application Publication
(10) Pub. No.: US 2010/0045422 A1
(43) Pub. Date: Feb. 25, 2010

(54) SENSOR NETWORK SYSTEM ENABLES HIGHLY-RELIABLE TRANSMISSION/RECEPTION OF CONTROL COMMAND AND EFFICIENT BAND

(75) Inventors: Rui Teng, Tokyo (JP); Tatsuya Yamazaki, Tokyo (JP); Yasuo Tan, Tokyo (JP); Takashi Matsuyama, Tokyo (JP); Hiromitsu Wakana, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NATIONAL INSTITUTE OF INFORMATION AND COMMUNICATIONS TECHNOLOGY, Tokyo (JP)

(21) Appl. No.: 12/543,043

(22) Filed: Aug. 18, 2009

(30) Foreign Application Priority Data
Aug. 21, 2008 (JP) 2008-213210
Jul. 27, 2009 (JP) 2009-174247

(51) Int. Cl. G05B 23/00

(52) U.S. Cl. 340/3.1

(57) ABSTRACT

If control periods at sensors are equal to each other, a control terminal transmits control commands intended for the sensors at a time to the sensors at the earliest control timing and the latest control timing among control timings at the sensors. If the control periods are different from each other, the control terminal transmits control commands intended for the sensors at a time to the sensors at the start timing and the end timing of the shortest control period. Further, if reception periods in data reception from a sensor is longer than a control period at the sensor, the control terminal transmits a control command to the sensor in response to data reception from the sensor.

### FIELD OF THE INVENTION

The invention relates to sensor network systems deployed in a domestic or work environment.

### DESCRIPTION OF THE RELATED ART

A conventional, known sensor system comprises a plurality of sensors and a controller (Joshua Lifton, Mark Feldmeier, Yasuhiro Ono, Cameron Lewis, and Joseph A. Paradiso, “A Platform for Ubiquitous Sensor Deployment in Occupational and Domestic Environments,” Proceedings of the 6th international conference on information processing in sensor networks, pp. 119-127, 2007.). The plurality of sensors provides ON/OFF control of electric equipment or continuous control of current and voltage. The controller controls the plurality of sensors.

When the plurality of sensors includes sensors A, B, C, and D, for example, the sensors A, B, C, and D have control periods TA, TB, TC, and TD, respectively. The controller transmits, to the sensor A, a control command for controlling the control timing of the electric equipment by the sensor A, periodically(at the same periods as the control periods TA) at timing tA. The controller also transmits, to the sensor B, a control command for controlling the control timing of the electric equipment by the sensor B, periodically(at the same periods as the control period TB) at timing tB. Thereafter, in the same manner, the controller transmits, respectively to the sensors C and D, a control command for controlling the control timing of the electric equipment by the sensors C and D, periodically (respectively at the same periods as the control periods TC and TD)at timings tC and tD, respectively.

As described above, the controller controls the plurality of sensors by transmitting separately control commands to the plurality of sensors.

### BRIEF SUMMARY OF THE INVENTION

Separate transmission of control commands to a plurality of sensors is problematic in that there occurs a frequent transmission of control commands from the controller to the plurality of sensors, which consumes more communication bandwidth.

In addition, if a communication medium is shared, it is problematic that transmission/reception of control commands may frequently fail due to packet loss.

Therefore, the invention is aimed at solving the aforementioned problems, and one of its objects is to provide a sensor network system enabling a narrowed communication bandwidth and transmission of a control command with higher reliability than data.

According to the invention, a sensor network system comprises a plurality of sensors and a control terminal. The plurality of sensors are provided corresponding to a plurality of electric equipments, and respectively detects data representing an operating state of the corresponding electric equipment and respectively controls the corresponding electric equipment. The control terminal carries out time allocation for transmitting a control command, and during the time allocated, transmits a plurality of control commands at a time to the plurality of sensors through a radio communication, the plurality of control commands being for the plurality of sensors to control the corresponding electric equipment. Each of the plurality of sensors transmits the detected data to the control terminal and controls the corresponding electric equipment at a control timing specified by the control command.

Preferably, the control terminal determines a transmission timing of the control command based on a plurality of control periods at the plurality of sensors and a plurality of control timings at the plurality of sensors and transmits the control command to the plurality of sensors through a radio communication at the determined transmission timing.

Preferably, if the plurality of control periods are equal to each other, the control terminal determines the earliest control timing and the latest control timing among the plurality of control timings to be the transmission timing.

Preferably, the control terminal transmits the plurality of control commands at a time to the plurality of sensors at the earliest control timing or the latest control timing after reception of the data from the plurality of sensors.

Preferably, if the plurality of control periods are different from each other, the control terminal determines the start timing and the end timing of the shortest control period among the plurality of control periods to be the transmission timing.

Preferably, the control terminal transmits the plurality of control commands at a time to the plurality of sensors at the start timing or the end timing after reception of the data from the plurality of sensors.

Preferably, if the total data size of the plurality of control commands is larger than a standard value, the control terminal transmits the plurality of control commands to the plurality of sensors by including the plurality of control commands in a plurality of packets each having a data size equal to or less than the standard value.

Preferably, if the plurality of control commands includes an unnecessary control command, the control terminal compares the total data size of the rest of the control commands other than the unnecessary control command with the standard value, and if the total data size of the rest of the control commands is larger than the standard value, transmits the rest of the control commands by including the rest of the control commands in the plurality of packets.

Preferably, the control terminal transmits the number of the plurality of packets by including the number in a packet first to be transmitted among the plurality of packets.

According to the invention, a sensor network system comprises a plurality of sensors and a control terminal. The plurality of sensors are provided corresponding to a plurality of electric equipments, and respectively detects data representing an operating state of the corresponding electric equipment and respectively controls the corresponding electric equipment. The control terminal transmits, to a sensor controlling the electric equipment, a control command for the sensor controlling the electric equipment to control the corresponding electric equipment, upon reception of the data from the sensor controlling the electric equipment. The sensor controlling the electric equipment controls the corresponding electric equipment at a control timing specified by the control command.

Preferably, if the data size of the control command is larger than a standard value, the control terminal transmits the control command to the sensor controlling the electric equipment by including the control command in a plurality of packets each having a data size equal to or less than the standard value.

According to the invention, a control terminal transmits control commands intended for a plurality of sensors at a time to the plurality of sensors, and each of the plurality of sensors extracts a control command intended for oneself from the plurality of control commands transmitted from the control terminal, controls the corresponding electric equipment according to the extracted control command, and detects data of the corresponding electric equipment. As a result, the number of transmission of control commands from the control terminal to a plurality of sensors is less than that of separate transmission of control commands to a plurality of sensors.

Therefore, the invention enables a narrow communication band. In addition, since time allocation for transmitting a control command is carried out within a fixed communication band, the control command is less likely to be subjected to packet loss etc. and is transmitted with higher reliability than data.

### BRIEF DESCRIPTION OF THE DRAWINGS

FIG. 1 is a schematic view of a sensor network system according to Embodiment 1 of the invention.

FIG. 2 is a schematic block diagram illustrating the configuration of the control terminal shown in FIG. 1.

FIG. 3 is a schematic block diagram illustrating the configuration of the sensor shown in FIG. 1.

FIG. 4 is a timing chart representing a transmission timing of a control command according to Embodiment 1.

FIG. 5 is a timing chart representing another transmission timing of a control command according to Embodiment 1.

FIG. 6 is a timing chart representing another transmission timing of a control command according to Embodiment 1.

FIG. 7 is a timing chart representing another transmission timing of a control command according to Embodiment 1.

FIG. 8 illustrates a format of a packet for transmitting a control command.

FIG. 9 is a conceptual diagram of control terms and data collection terms.

FIG. 10 is a flowchart illustrating the operations for determining the method of controlling the respective sensors.

FIG. 11 is a flowchart to explain the operations using the control method MTH1 according to Embodiment 1.

FIG. 12 illustrates a concrete example of a packet including a plurality of control commands.

FIG. 13 is a flowchart to explain the operations using the control method MTH2 according to Embodiment 1.

FIG. 14 is a flowchart to explain the operations using the control method MTH3 according to Embodiment 1.

FIG. 15 is a flowchart to explain the operations using the control method MTH4 according to Embodiment 1.

FIG. 16 illustrates a simulation outcome of the sensor network system shown in FIG. 1.

FIG. 17 illustrates another simulation outcome of the sensor network system shown in FIG. 1.

FIG. 18 is a schematic view of a sensor network system according to Embodiment 2.

FIG. 19 is a schematic block diagram illustrating the configuration of the control terminal shown in FIG. 18.

FIG. 20 is a figure to explain a method of producing a plurality of packets including a plurality of control commands.

FIG. 21 is a figure to explain another method of producing a plurality of packets including a plurality of control commands.

FIG. 22 is a timing chart illustrating transmission timings of a control command according to Embodiment 2.

FIG. 23 is a timing chart illustrating other transmission timings of a control command according to Embodiment 2.

FIG. 24 is a timing chart illustrating other transmission timings of a control command according to Embodiment 2.

FIG. 25 is a timing chart illustrating other transmission timings of a control command according to Embodiment 2.

FIG. 26 is a flowchart to explain the operations using the control method MTH1 according to the Embodiment 2.

FIG. 27 is a flowchart to explain the operations using the control method MTH2 according to Embodiment 2.

FIG. 28 is a flowchart to explain the operations using the control method MTH3 according to Embodiment 2.

FIG. 29 is a flowchart to explain the operations using the control method MTH4 according to Embodiment 2.

FIG. 30 is a figure to explain another method of producing a plurality of packets including a plurality of control commands.

### DETAILED DESCRIPTION OF THE INVENTION

Embodiments of the present invention will be described in detail with reference to the figures. In the figures, identical or corresponding components are denoted by the same reference characters and description thereof will not be repeated.

### Embodiment 1

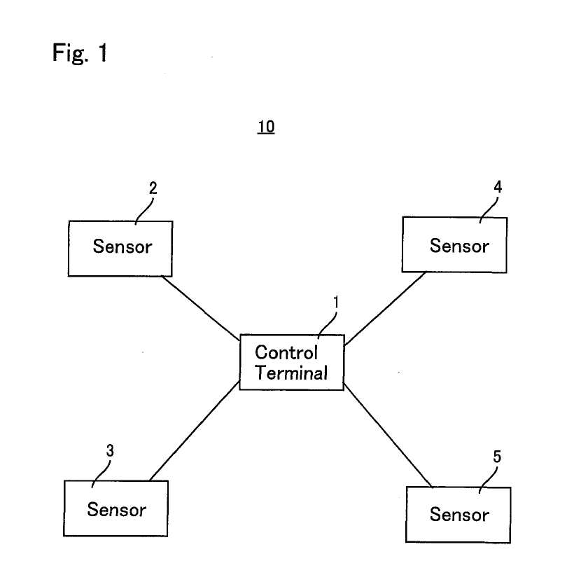

FIG. 1 is a schematic view of a sensor network system according to Embodiment 1 of the invention. With reference to FIG. 1, a sensor network system 10 according to an embodiment of the invention comprises a control terminal 1 and sensors 2-5.

The sensors 2-5 are provided corresponding to individual electric equipment and provided in a communication range of the control terminal 1. Each of the sensors 2-5 includes one of the sensors listed in Table 1.

TABLE 1

| Type of Sensor | Individual Command Content | Common Command Content |
|---|---|---|
| Current Sensor | ON/OFF Control of Electric | Sampling Rate of |
| Voltage Sensor | Equipment | Sensor |
| | Continuous Control of | Data Transmission Rate |
| | Current/Voltage | Data Transmission |
| Water-Current | ON/OFF Control of Water Current | Period |
| Sensor | Continuous Control of Water | |
| Water-Pressure | Volume | |
| Sensor | | |
| Gas Sensor | ON/OFF Control of Gas | |
| | Continuous Control of Gas Volume | |
| Illuminance Sensor | ON/OFF Control of Illumination | |
| | Electric Equipment | |
| | Continuous Control of | |
| | Illumination | |
| Wind-Speed Sensor | ON/OFF Control of Wind-Related | |
| | Equipment | |
| | Continuous Control of Air Volume | |
| Temperature Sensor | ON/OFF Control of Heating/Cooling | |
| | Equipment | |
| | Continuous Control of Temperature | |
| Humidity Sensor | ON/OFF Control of | |
| | Humidifying/Dehumidifying | |
| | Equipment | |
| | Continuous Control of Humidity | |
| Human-Detection | ON/OFF Control of Home Appliance | |
| Sensor | | |
| Camera Sensor | ON/OFF Control of Home Appliance | |
| Sound Sensor | ON/OFF Control of Home Appliance | |
| | Continuous Control of Sound | |
| | Volume | |
| Pressure Sensor | ON/OFF Control of Home Appliance | |

The control terminal 1 receives data on the electric equipment, which has been detected by each of the sensors 2-5, directly from the sensors 2-5 through a radio communication. Then, the control terminal 1 receives a plurality of control timings from a sensor j (j=2-5), and based on the received plurality of control timings, detects control periods Tcj of the electric equipment at the sensor j. The control terminal 1 executes this operation with respect to all of the sensors 2-5, and detects a plurality of control periods Tc2-Tc5 at the plurality of sensors 2-5. The control terminal 1 also detects reception interval ITRj in data reception from the sensor j. The control terminal 1 executes this operation with respect to all of the sensors 2-5 and detects reception intervals ITR2-ITR5 of data from the plurality of sensors 2-5.

Then, based on the detected plurality of control periods Tc2-Tc5 and reception intervals ITR2-ITR5, the control terminal 1 determines by using the methods described below a transmission timing transmitting a control command, for the respective sensors 2-5 to control their corresponding electric equipment, and transmits a control command to the sensors 2-5 at the determined transmission timing. In this case, the control command contains individual command content and common command content corresponding to the respective sensors in Table 1.

Each of the sensors 2-5 transmits, to the control terminal 1, a control request including a plurality of control timings of the electric equipment at the oneself.

Each of the sensors 2-5 also receives a control command from the control terminal 1, controls the corresponding electric equipment based on the received control command, and detects data representing the operating state of the corresponding electric equipment. Then, each of the sensors 2-5 transmits directly the detected data to the control terminal 1 through a radio communication.

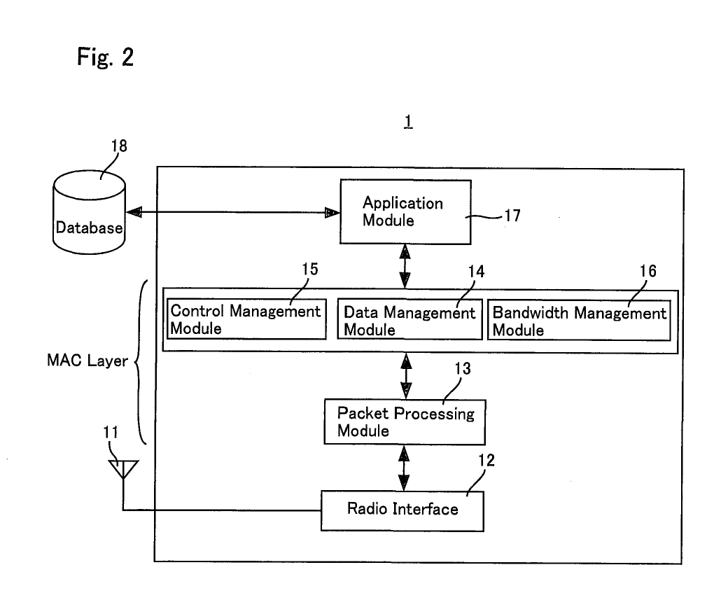

FIG. 2 is a schematic block diagram illustrating the configuration of the control terminal 1 shown in FIG. 1. With reference to FIG. 2, the control terminal 1 includes an antenna 11, a radio interface 12, a packet processing module 13, a data management module 14, a control management module 15, a bandwidth management module 16, an application module 17, and a database 18.

The antenna 11 receives, from the sensors 2-5, a packet including data or a control request through a radio communication space and outputs the received packet to the radio interface 12. The antenna 11 also transmits a packet received from the radio interface 12 to the sensors 2-5 through a radio communication space.

The radio interface 12 receives a packet from the packet processing module 13 and executes a physical-layer operation such as modulation and the like on the received packet. Then, the radio interface 12 transmits the packet through the antenna 11.

The radio interface 12 also receives a packet from the antenna 11 and executes a physical-layer operation such as demodulation and the like on the received packet. Then, the radio interface 12 outputs the packet to the packet processing module 13.

The packet processing module 13 belongs to the MAC (Media Access Control) layer. Upon receiving a packet from the data management module 14, the packet processing module 13 adds a header to the received packet and outputs it to the radio interface 12.

In addition, upon receiving a packet from the radio interface 12, the packet processing module 13 deletes the header of the received packet and outputs the packet to the data management module 14.

The data management module 14 belongs to the MAC layer, and upon receiving a packet from the packet processing module 13, if the received packet includes a plurality of control timings at the sensor j, extracts the plurality of control timings and the source of the packet from the packet and outputs the plurality of control timings and the source to the control management module 15 and the bandwidth management module 16. If the received packet includes a tolerable control delay TCD_j of the sensor j, the data management module 14 extracts the tolerable control delay TCD_j and the source of the packet from the packet and outputs the tolerable control delay TCD_j and the source to the control management module 15 and the bandwidth management module 16. Further, if the received packet includes data detected by the sensor j, the data management module 14 detects the reception timing of the received packet and outputs the detected reception timing and the source of the packet to the bandwidth management module 16. Further, if the received packet includes data detected by the sensor j, the data management module 14 extracts the data and the source from the packet and outputs the data and the source to the application module 17.

The data management module 14 receives, from the application module 17, a plurality of control commands intended for the sensors 2-5 and, from the control management module 15, a transmission timing for transmitting the control commands to the sensors 2-5.

Upon receiving any one of control methods MTH1, MTH2 and MTH3, which will be described below, from the bandwidth management module 16, the data management module 14 produces a packet including a plurality of control commands and transmits the produced packet to the sensors 2-5 at the transmission timing received form the control management module 15. After that, the data management module 14 transmits a packet including a plurality of control commands to the sensors 2-5, upon each reception of a transmission timing from the control management module 15.

Upon receiving a control method MTH4, which will be described below, from the bandwidth management module 16, the data management module 14 produces a packet including a control command intended for the sensor j that has transmitted data to the control terminal 1 and transmits the produced packet to the sensor j at the transmission timing received from the control management module 15. After that, the data management module 14 transmits, to the sensor j, a packet including a control command intended for the sensor j, upon each reception of a transmission timing from the control management module 15.

The control management module 15 belongs to the MAC layer and receives, from the data management module 14, a plurality of control timings and a tolerable control delay and a source, and from the bandwidth management module 16, a control method (any one of the control methods MTH1-MTH4) for controlling the sensors 2-5. Then, based on the received control method, plurality of control timings, tolerable control delay, and source, the control management module 15 determines the transmission timing of a control command by using the method described below and outputs the determined transmission timing to the data management module 14.

The bandwidth management module 16 belongs to the MAC layer and receives, from the data management module 14, a plurality of reception timings of data, a plurality of control timings, a source, and a tolerable control delay. Then, based on the received plurality of reception timings, plurality of control timings, source, and tolerable control delay, the bandwidth management module 16 determines the control method (any one of the control methods MTH1-MTH4) for controlling the sensors 2-5 by using the methods described below and outputs the determined control method to the data management module 14 and the control management module 15.

The application module 17 receives, from the data management module 14, data and the source of the data. Then, if the received data includes data detected by the respective sensors 2-5, the application module 17 links the data and the source and stores them into the database 18. If the received data includes a control request, the application module 17 produces a control command for controlling the respective sensors 2-5 by referring to Table 1 and outputs the control command to the data management module 14.

The database 18 stores the source and the data as they are linked.

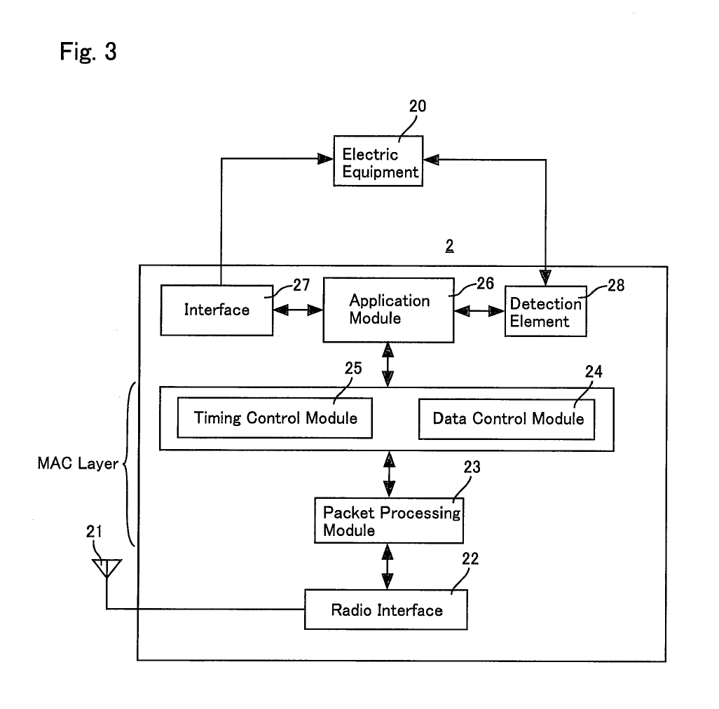

FIG. 3 is a schematic block diagram illustrating the configuration of the sensor 2 shown in FIG. 1. With reference to FIG. 3, the sensor 2 includes an antenna 21, a radio interface 22, a packet processing module 23, a data control module 24, a timing control module 25, an application module 26, and an interface 27, and a detection element 28.

The antenna 21 receives a packet including a control command from the control terminal 1 through a radio communication space and outputs the received packet to the radio interface 22. The antenna 21 also transmits a packet received from the radio interface 22 to the control terminal 1 through a radio communication space.

The radio interface 22 receives a packet from the packet processing module 23 and executes a physical-layer operation such as modulation and the like on the received packet. Then, the radio interface 22 transmits the packet through the antenna 21.

The radio interface 22 also receives a packet from the antenna 21 and executes a physical-layer operation such as demodulation and the like on the received packet. Then, the radio interface 22 outputs the packet to the packet processing module 23.

The packet processing module 23 belongs to the MAC layer. Upon receiving a packet from the data control module 24, the packet processing module 23 adds a header to the received packet and outputs it to the radio interface 22.

Upon receiving the packet from a radio interface 22, the packet processing module 23 deletes the header from the received packet and outputs the packet to the data control module 24.

The data control module 24 belongs to the MAC layer. The data control module 24 receives a packet including a control command from the packet processing module 23 and outputs the received packet to the timing control module 25 and the application module 26.

Upon receiving a tolerable control delay TCD_2 from the application module 26, the data control module 24 produces a packet including the received tolerable control delay TCD_2 and outputs the packet to the packet processing module 23.

Further, upon receiving data representing the operating state of electric equipment 20 from the application module 26, the data control module 24 produces a packet including the received data and outputs the packet to the packet processing module 23.

Further, upon receiving a control request, from the application module 26, including a plurality of control timings of the electric equipment 20 at the sensor 2, the data control module 24 produces a packet including the received control request and outputs the packet to the packet processing module 23.

The timing control module 25 belongs to the MAC layer. The timing control module 25 receives a packet from the data control module 24 and extracts, from the received packet, a control command intended for the sensor 2. Then, the timing control module 25 fetches the control timing at the sensor 2, which is specified by the extracted control command, and based on the fetched control timing, determines a control term of the electric equipment 20 at the sensor 2 and a data collection term of the electric equipment 20. Then, the timing control module 25 outputs the determined control term and data collection term to the application module 26.

The application module 26 produces a control request including a plurality of control timings of the electric equipment 20 at the sensor 2 and outputs the control request to the data control module 24. The application module 26 also detects the tolerable control delay TCD_2 of the sensor 2 and outputs the detected tolerable control delay TCD_2 to the data control module 24. Further, the application module 26 receives a control term and a data collection term from the timing control module 25, and receives a packet including a plurality of control commands, from the data control module 24. Then, the application module 26 extracts, from the received packet, a control command intended for the sensor 2 and detects the command content included in the extracted control command.

Then, for the control term received from the timing control module 25, the application module 26 controls the electric equipment 20 according to the detected command content through the interface 27. When the control term ends, the application module 26 controls the detection element 28 for the data collection term and according to the detected command content so as to detect data representing the operating state of the electric equipment 20. Further, upon receiving data from the detection element 28, the application module 26 outputs the received data to the data control module 24.

The interface 27 is used by the application module 26 for controlling the electric equipment 20.

The detection element 28 detects data representing the operating state of the electric equipment 20 according to the control from the application module 26 and output the detected data to the application module 26.

Note that each of the sensors 3-5 shown in FIG. 1 has the same configuration as that of the sensor 2 shown in FIG. 3.

Explained below is how to determine the method of controlling the sensors 2-5 by the bandwidth management module 16 of the control terminal 1.

The bandwidth management module 16 of the control terminal 1 receives, from the data management module 14, a plurality of control timings tc1_2, tc2_2, tc3_2, . . . at the sensor 2, the address Add2 of the sensor 2, a plurality of reception timings tr1_2, tr2_2, tr3₁₃ 2, . . . in data reception from the sensor 2, and tolerable control delays TCD_2-TCD_5 of the sensors 2-5. The tolerable control delays TCD_2-TCD_5 are control delays tolerable for the sensors 2-5, that is to say, are the maximum control periods at the sensors 2-5 and specific to the sensors 2-5. The bandwidth management module 16 then detects time intervals TI1_2, TI2_2, . . . between two adjacent control timings tc1_2, tc2_2; tc2_2, tc3_2; . . . of the received plurality of control timings tc1_2, tc2_2, tc3_2, . . . . The bandwidth management module 16 also detects reception intervals ITR1_2, ITR2_2, . . . between two adjacent reception timings tr1_2, tr2_2; tr2₁₃ 2, tr3_2; . . . of the plurality of reception timings tr1_2, tr2₁₃ 2, tr3_2, . . . .

Likewise, the bandwidth management module 16 of the control terminal 1 also detects, with respect to the sensors 3-5, time intervals TI1_3, TI2_3, . . . ; TI1_4, TI2_4, . . . ; TI1_5, TI2_5, . . . between two adjacent control timings and reception intervals ITR1_3, ITR2_3, . . . ; ITR1_4, ITR2_4, . . . ; ITR1_5, ITR2_5, . . . of two adjacent reception timings.

If the plurality of time intervals TI1_2, TI2₁₃ 2, . . . detected with respect to the sensor 2 are equal to each other, the control terminal 1 detects the time intervals TI1_2, TI2_2, . . . as the control period Tc2 at the sensor 2. Likewise, if the plurality of time intervals TI1_3, TI2_3, . . . ; TI1_4, TI2_4, . . . ; TI1_5, TI2₁₃ 5, . . . detected with respect to the sensors 3-5 are equal to each other, the control terminal 1 detects the time intervals TI1_3, TI2_3, . . . ; TI1₁₃ 4, TI2_4, . . . ; TI1_5, TI2_5, . . . as the control periods Tc3-Tc5 at the sensors 3-5, respectively.

Then, the bandwidth management module 16 of the control terminal 1 determines whether the detected control periods Tc2-Tc5 are equal to each other. If the control periods Tc2-Tc5 are equal to each other, the bandwidth management module 16 of the control terminal 1 determines the control method MTH1, as the method of controlling the sensors 2-5, for transmitting a plurality of control commands intended for the sensors 2-5, at a time to the sensors 2-5, at the earliest control timing and the latest control timing among the control timings tc_2, tc_3, tc_4, and tc_5 of the sensors 2-5.

On the other hand, if the control periods Tc2-Tc5 are not equal to each other, the bandwidth management module 16 of the control terminal 1 further determines whether the control periods Tc2-Tc5 are shorter than the reception intervals ITR1_2, ITR2_2, . . . ; ITR1_3, ITR2_3, . . . ; ITR1_4, ITR2_4, . . . ; ITR1_5, ITR2_5, . . . .

If the control periods Tc2-Tc5 are not shorter than the reception intervals ITR1_2, ITR2_2, . . . ; ITR1_3, ITR2_3, . . . ; ITR1_4, ITR2_4, . . . ; ITR1_5, ITR2_5, . . . , the bandwidth management module 16 of the control terminal 1 determines the control method MTH2, as the method of controlling the sensors 2-5, for transmitting a plurality of control commands intended for the sensors 2-5 at the start timing and the end timing of the shortest control period among the control periods Tc2-Tc5.

On the other hand, if the control periods Tc2-Tc5 are shorter than the reception intervals ITR1_2, ITR2_2, . . . ; ITR1_3, ITR2_3, . . . ; ITR1_4, ITR2_4, . . . ; ITR1_5, ITR2_5, . . . , the bandwidth management module 16 of the control terminal 1 further determines whether there is a control request from the sensors 2-5.

If there is no control request, the bandwidth management module 16 of the control terminal 1 selects, from the start timing and the end timing of the shortest control period among the control periods Tc2-Tc5, a start timing or an end timing that is the closest to the earliest control timing, and a start timing or an end timing that is the closest to the end timing of the shortest tolerable control delay (=any one of the tolerable control delays TCD_2-TCD_5) to determine the control method MTH3, as the method of controlling the sensors 2-5, for transmitting a plurality of control commands intended for the sensors 2-5 at a time at the selected start timing or end timing.

On the other hand, if there is the control request, the bandwidth management module 16 of the control terminal 1 determines the control method MTH4, as the method of controlling the sensors 2-5, for transmitting a control command to each of the sensors 2-5 in response to data reception from each of the sensors 2-5.

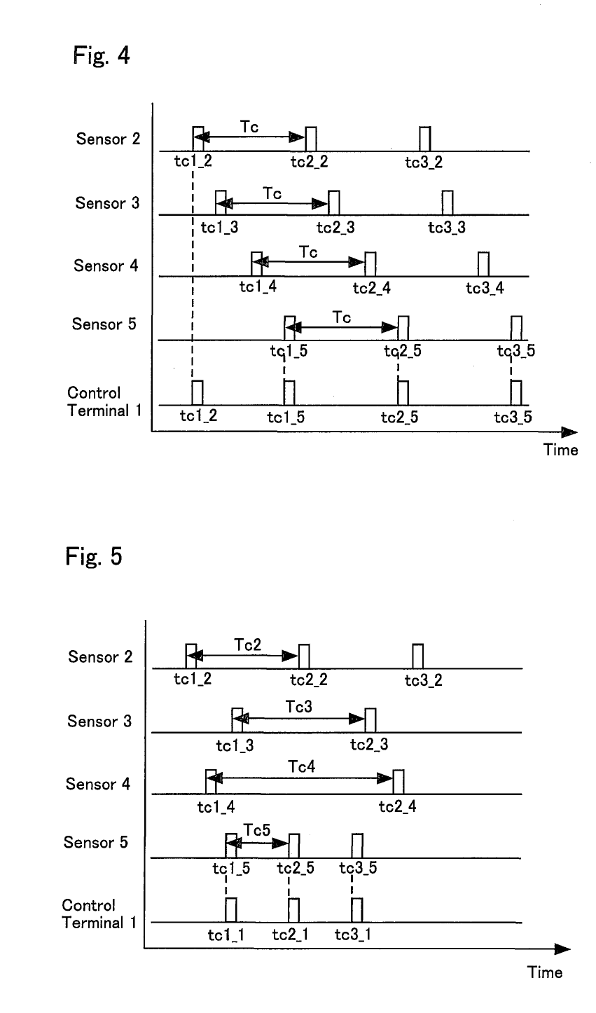

FIG. 4 is a timing chart representing a transmission timing of a control command according to Embodiment 1. With reference to FIG. 4, if the control method MTH1 is determined to be the method of controlling the sensors 2-5, the control periods Tc2-Tc5 of the sensors 2-5 are equal to each other (Tc2=Tc3=Tc4=Tc5=Tc).

The individual control timings of the sensors 2-5 are control timings tc1_2, tc1_3, tc1_4, and tc1_5, respectively.

Accordingly, the control management module 15 of the control terminal 1 broadcasts, to the sensors 2-5, a packet including a plurality of control commands at the earliest control timing tc1_2 among the control timings tc1_2, tc1_3, tc1_4, and tc1_5. Then, the control management module 15 of the control terminal 1 broadcasts, to the sensors 2-5, a packet including a plurality of control commands at the latest control timing tc1_5 among the control timings tc1_2, tc1_3, tc1_4, and tc1_5. Thereafter, the control management module 15 of the control terminal 1 broadcasts, to the sensors 2-5, a packet including a plurality of control commands at the latest control timing tc2_5 among the control timings tc2_2, tc2_3, tc2_4, and tc2_5, and broadcasts, to the sensors 2-5, a packet including a plurality of control commands at the latest control timing tc3_5 among the control timings tc3_2, tc3_3, tc3_4, and tc3_5.

Conventionally, a control command is transmitted to the sensor 2 at the control timings tc1_2, tc2_2, tc3_2, . . . , to the sensor 3 at the control timings tc1_3, tc2_3, tc3_3, . . . , to the sensor 4 at the control timings tc1_4, tc2_4, tc3_4, . . . , and to the sensor 5 at the control timings tc1_5, tc2_5, tc3_5, . . .

According to the invention, however, the control terminal 1 transmits a plurality of control commands intended for the sensors 2-5, at a time to the sensors 2-5, at the control timings tc1_2, tc1_5, tc2_5, tc3_5, . . . . As a result, the number of transmission of control commands to the sensors 2-5 decreases.

Therefore, the invention enables a narrow communication band. In addition, since time allocation for transmitting a control command is carried out within a fixed communication band, the control command is less likely to be subjected to packet loss etc. and is transmitted with higher reliability than data.

Note that the control method MTH1 may transmit a plurality of control commands intended for the sensors 2-5, at a time to the sensors 2-5, at the start timing and the end timing of the control period Tc2 having the earliest start timing among those of the control periods Tc2-Tc5. In this case, the control terminal 1 periodically transmits a plurality of control commands intended for the sensors 2-5, at a time to the sensors 2-5, at the control timings tc1_2, tc2_2, tc3_2, . . . .

FIG. 5 is a timing chart representing another transmission timing of a control command according to Embodiment 1. With reference to FIG. 5, if the control method MTH2 is determined to be the method of controlling the sensors 2-5, the control periods Tc2-Tc5 of the sensors 2-5 are different from each other (Tc5<Tc2<Tc3<Tc4).

Accordingly, the control management module 15 of the control terminal 1 selects the shortest control period Tc5 from the control periods Tc2-Tc5 and transmits a plurality of control commands, at a time to the sensors 2-5, at the transmission timings tc1_5, tc2_5, and tc3_5 (=tc1_1, tc2_1, and tc3_1) which are the start timing or the end timing of the selected control period Tc5.

With the control method MTH2, the control terminal 1 also transmits a plurality of control commands at a time to the sensors 2-5, and therefore, the number of transmission of control commands to sensors 2-5 decreases.

Therefore, the invention enables a narrow communication band. In addition, since time allocation for transmitting a control command is carried out within a fixed communication band, and therefore, the control command is less likely to be subjected to packet loss etc. and is transmitted with higher reliability than data.

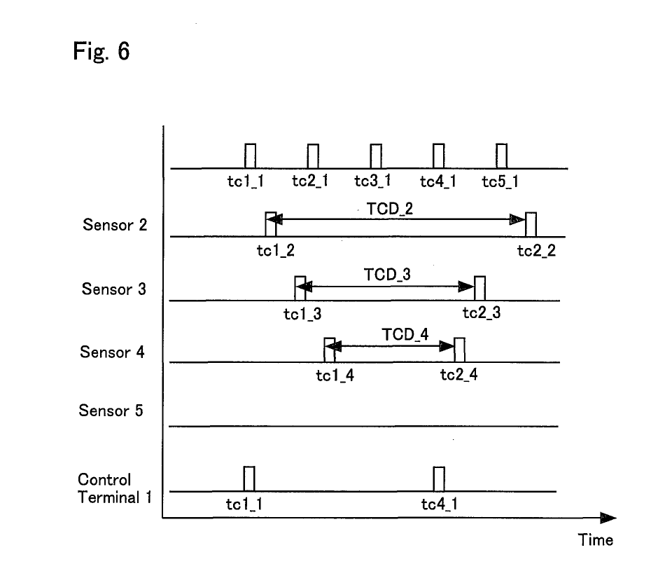

FIG. 6 is a timing chart representing another transmission timing of a control command according to Embodiment 1. With reference to FIG. 6, if the control method MTH3 is determined to be the method of controlling the sensors 2-5, the control periods Tc2-Tc5 of the sensors 2-5 are different from each other (Tc5<Tc2<Tc3<Tc4), and the control terminal 1 receives no control request from the sensors 2-5.

Then, as in the case where the control method MTH2 is selected, the control management module 15 of the control terminal 1 selects the shortest control period Tc5 among the control periods Tc2-Tc5 and detects the timings tc1_1, tc2_1, tc3_1, tc4_1, and tc5_1 which are the start timing or the end timing of the selected control period Tc5. The control management module 15 of the control terminal 1 also receives tolerable control delays TCD_2-TCD_4 of the sensors 2-4, respectively from the sensors 2-4.

Then, the control management module 15 of the control terminal 1 determines, as the transmission timing of the control command, the timing tc1_1 that is the closest to the earliest control timing tc1_2 and the timing tc4_1 that is the closest to the end timing tc2_4 of the shortest tolerable control delay TCD_4, among the timings tc1_1, tc2_1, tc3_1, tc4_1, and tc5_1. Then, the control management module 15 of the control terminal 1 transmits a plurality of control commands, at a time to the sensors 2-5, at the transmission timings tc1_1 and tc4_1.

With the control method MTH3, the control terminal 1 also transmits a plurality of control commands at a time to the sensors 2-5, and stops transmitting unnecessary control commands, and therefore, the number of transmission of control commands to the sensors 2-5 decreases.

Therefore, the invention enables a narrow communication band. In addition, time allocation for transmitting a control command is carried out within a fixed communication band, the control command is less likely to be subjected to packet loss etc. and is transmitted with higher reliability than data.

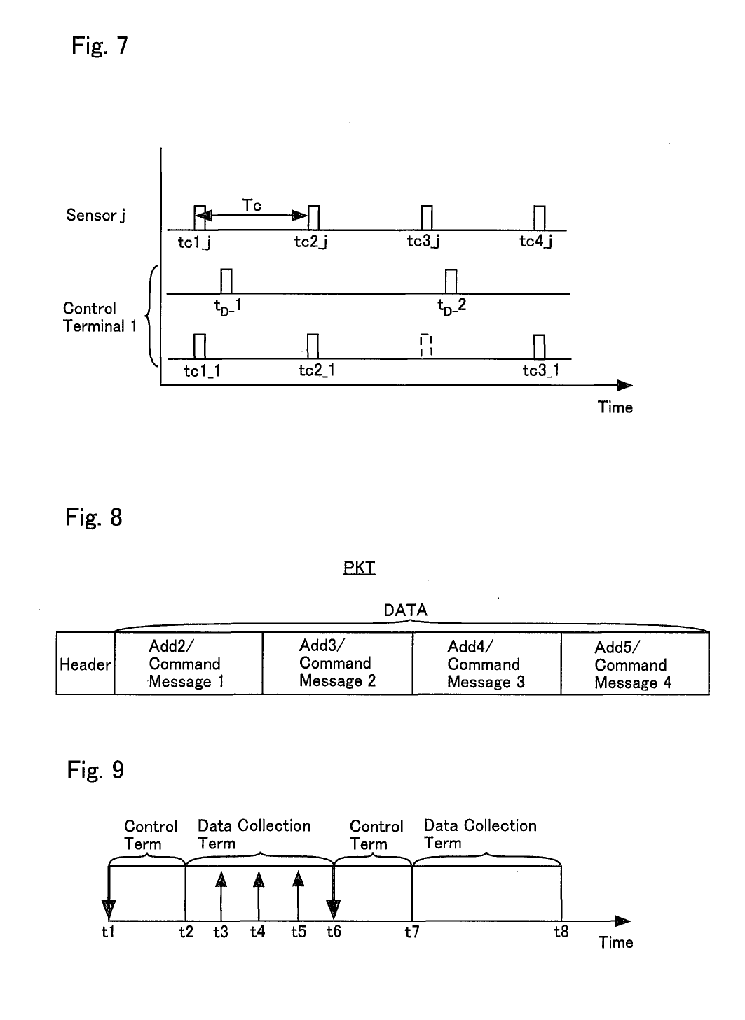

FIG. 7 is a timing chart representing another transmission timing of a control command according to Embodiment 1. With reference to FIG. 7, assume that if the control period at the sensor j is Tc and the control timing is tc1_{—}j, tc2_{—}j, tc3_{—}j, . . . , the control terminal 1 receives data from the sensor j at the reception timing tD_1, tD_2, . . . .

In this case, before receiving data at the reception timing tD_1, the control management module 15 of the control terminal 1 transmits a control command to the sensor j at the control timing tc1_1 synchronized with the control timing tc1_{—}j. After receiving data at the reception timing tD_1, the control management module 15 of the control terminal 1 transmits a control command to the sensor j at the control timing tc2_1 synchronized with the control timing tc2_{—}j and transmits a control command to the sensor j at the control timing tc3_1 synchronized with the control timing tc4_{—}j. As a result, no control command is transmitted to the sensor j at a control timing synchronized with the control timing tc3_{—}j.

Therefore, with the control method MTH4, if no data is actually transmitted from the sensor j to the control terminal 1, transmission of a control command from the control terminal 1 to the sensor j is stopped. As a result, the number of transmission of control commands from the control terminal 1 to the sensor j decreases.

Therefore, the invention enables a narrow communication band.

FIG. 8 illustrates a format of a packet for transmitting a control command. With reference to FIG. 8, a packet PKT includes a header and data DATA. The data DATA includes Address Add2/Command Message 1, Address Add3/Command Message 2, Address Add4/Command Message 3, and Address Add5/Command Message 4. Note that in Embodiment 1, a packet including a control command as data has a data size of 100 bytes or less.

The Address Add2/Command Message 1 is a control command intended for the sensor 2. The command message 1 includes the control timing tc_2 (=tc1_2, tc2_2, tc3_2, . . . ) at the sensor 2 and the command content (individual command content and common command content) provided in Table 1.

Likewise, the Address Add3/Command Message 2, the Address Add4/the command message 3, and the Address Add5/Command Message 4 are respectively control commands intended for the sensors 3-5, and the command messages 2-4 respectively include the control timing tc_3 (=tc1_3, tc2_3, tc3_3, . . . )−tc_5 (=tc1_5, tc2_5, tc3_5, . . . ) at the sensors 3-5 and the command content (individual command content and common command content) provided in Table 1.

Therefore, if the control methods MTH1 and MTH2 are used, upon receiving a transmission timing of a control command intended for the sensors 2-5 and a control timing of the respective sensors 2-5 from the control management module 15, and a control command (=command content) intended for the respective sensors 2-5 from the application module 17, the data management module 14 of the control terminal 1 stores the control timing at the sensor 2 and the control command (=command content) intended for the sensor 2 into the Add2/Command Message 1, the control timing at the sensor 3 and the control command (=command content)intended for the sensor 3 into the Add3/Command Message 2, the control timing at the sensor 4 and the control command (=command content) intended for the sensor 4 into the Add4/Command Message 3, and the control timing at the sensor 5 and the control command (=command content) intended for the sensor 5 into the Add5/Command Message 4, to produce aggregate control commands intended for the sensors 2-5. Then, the data management module 14 of the control terminal 1 transmits the produced aggregate control commands to the sensors 2-5 at the transmission timings tc1_2, tc1_5, tc2_5, tc3_5, . . . (or at the transmission timings tc1_5, tc2_5, tc3_5, . . . ).

If the control method MTH3 is used, the data management module 14 of the control terminal 1 produces a control command including only a command message j intended for the sensor j that has transmitted data to the control terminal 1 and transmits the control command to the sensor j at the transmission timings tc1_1, tc2_1, tc3_1, . . . .

FIG. 9 is a conceptual diagram of control terms and data collection terms. Note that in FIG. 9, the down-pointing arrow represents reception of a control command in the respective sensors 2-5, and the up-pointing arrow represents transmission of data to the control terminal 1.

With reference to FIG. 9, if each of the sensors 2-5 receives a control command from the control terminal 1 at the timing t1, the time period between the timing t1 and the timing t2 is the control term of the electric equipment 20 of the respective sensors 2-5. Thereafter, it will be a data collection term at the respective sensors 2-5, and the sensors 2-4 respectively transmit data to the control terminal 1 at timings t3-t5.

Then, the time period between the timings t6-t7 is a control term and, that between the timing t7 and the timing t8 is a data collection term.

As described above, control terms and data collection terms are periodically set with respect to each of the sensors 2-5, and the respective sensors 2-5 control the electric equipment 20 and collect data representing the operating state of the electric equipment 20.

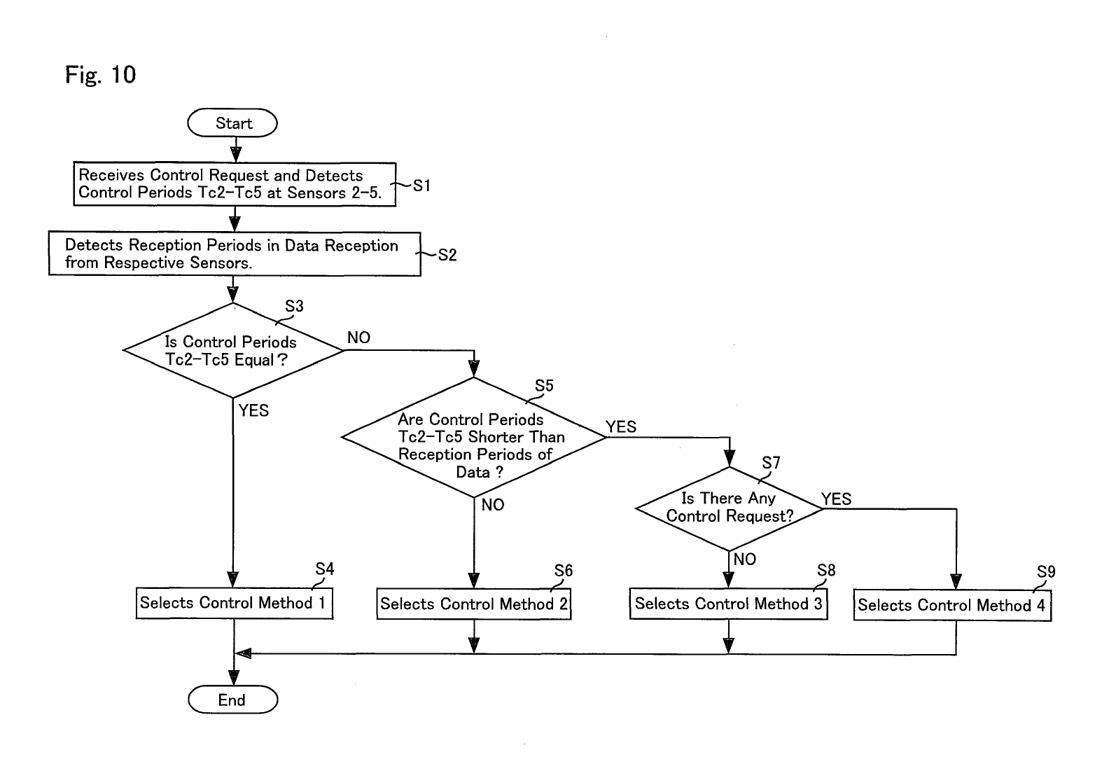

FIG. 10 is a flowchart illustrating the operations for determining the method of controlling the respective sensors 2-5. With reference to FIG. 10, once a series of operations has started, the bandwidth management module 16 of the control terminal 1 receives a control request from the sensors 2-5 and detects the control periods Tc2-Tc5 of the sensors 2-5 (Step S1).

Then, the bandwidth management module 16 of the control terminal 1 receives, from the data management module 14, a plurality of reception timings in data reception from each sensor j, and based on the received plurality of reception timings, detects the reception periods of data reception from each sensor j (Step S2).

Then, the bandwidth management module 16 of the control terminal 1 determined whether the control periods Tc2-Tc5 are equal to each other (Step S3).

If it is determined in Step S3 that the control periods Tc2-Tc5 are equal to each other, the bandwidth management module 16 of the control terminal 1 determines the control method MTH1 to be the method of controlling the sensors 2-5 (Step S4).

On the other hand, if it is determined in Step S3 that the control periods Tc2-Tc5 are different from each other, the bandwidth management module 16 of the control terminal 1 further determines whether the control periods Tc2-Tc5 are shorter than the reception periods of data (Step S5).

If it is determined in Step S5 that the control periods Tc2-Tc5 are not shorter than the reception periods of data, the bandwidth management module 16 of the control terminal 1 determines the control method MTH2 to be the method of controlling the sensors 2-5 (Step S6).

On the other hand, if it is determined in Step S5 that the control periods Tc2-Tc5 are shorter than the reception periods of data, the bandwidth management module 16 of the control terminal 1 further determines whether there is a control request from the sensors 2-5 (Step S7).

If it is determined in Step S7 that there is no control request, the bandwidth management module 16 of the control terminal 1 determines the control method MTH3 to be the method of controlling the sensors 2-5 (Step S8).

On the other hand, if it is determined in Step S7 that there is a control request, the bandwidth management module 16 of the control terminal 1 determines the control method MTH4 to be the method of controlling the sensors 2-5 (Step S9).

After any of Step S4, Step S6, Step S8, and Step S9, the series of operations ends.

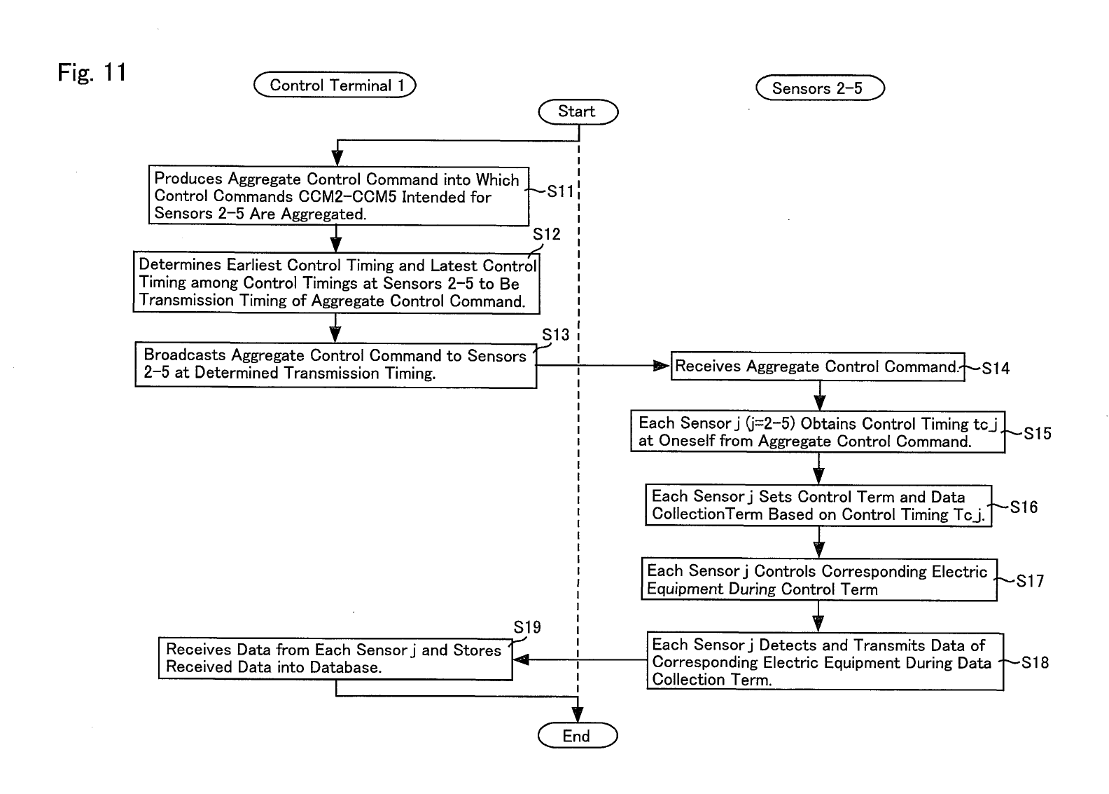

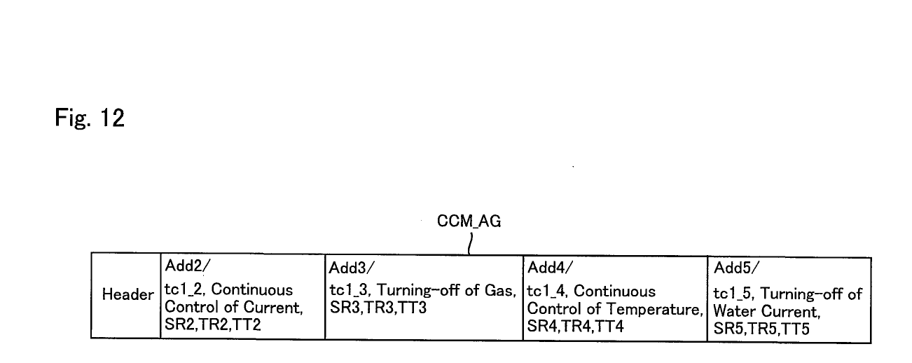

FIG. 11 is a flowchart to explain the operations using the control method MTH1 according to Embodiment 1. FIG. 12 illustrates a concrete example of a packet including a plurality of control commands.

With reference to FIG. 11, once a series of operations has started, the data management module 14 of the control terminal 1 produces aggregate control commands CCM_AG (refer to FIG. 12)into which control commands CCM2-CCM5 intended for the sensors 2-5 are aggregated (Step S11).

Then, based on the control method MTH1 received from the bandwidth management module 16, the control management module 15 of the control terminal 1 determines the earliest control timing and the latest control timing among the control timings of the sensors 2-5 to be the transmission timings of the aggregate control commands (Step S12) and outputs the determined transmission timings to the data management module 14.

Then, the data management module 14 of the control terminal 1 broadcasts the aggregate control commands CCM_AG to the sensors 2-5 at the transmission timings determined by the control management module 15 (Step S13).

The sensors 2-5 receive the aggregate control commands CCM_AG (Step S14). Then, the timing control module 25 of the sensor j obtains its own control timing tc_j (=any one of tc1_2, tc1_3, tc1_4, and tc1_5) from the aggregate control commands CCM_AG (Step S15).

After that, based on the obtained control timing tc_j, the timing control module 25 of the sensor j sets a control term and a data collection term (Step S16).

Then, the application module 26 of the sensor j controls the corresponding electric equipment 20 for the control term (Step S17).

The application module 26 of the sensor j controls, for the data collection term, the detection element 28 so as to detect data representing the operating state of the corresponding electric equipment 20, and the detection element 28 detects the data of the electric equipment 20 and outputs the data to the application module 26. Then, the application module 26 of the sensor j transmits the received data to the control terminal 1 (Step S18).

The application module 17 of the control terminal 1 receives data from each sensor j and stores the received data into the database 18 (Step S19), thereby ending the series of operations.

As described above, when the control method MTH1 is used, control commands intended for the sensors 2-5 are transmitted, at a time to the sensors 2-5, at the earliest control timing and the latest control timing among the control timings for the sensors 2-5. As a result, the number of transmission of control commands decreases.

Therefore, the invention enables a narrow communication band. In addition, since time allocation for transmitting a control command is carried out within a fixed communication band, and therefore, the control command is less likely to be subjected to packet loss etc. and is transmitted with higher reliability than data.

Now assume that the sensors 2-5 are a current sensor, a gas sensor, a temperature sensor, and a water-current sensor, respectively.

During the control term, the application module 26 of the sensor 2 continuously controls the current flowing across the corresponding electric equipment 20 based on the command content (=continuous control of current) intended for the sensor 2. Then, during the data collection term, the application module 26 of the sensor 2 detects, by the detection element 28, data of the electric equipment 20 in which the current is continuously controlled, at a sampling rate DR2. Then, the application module 26 of the sensor 2 periodically (=transmission period TT2) transmits the data detected by the detection element 28 to the control terminal 1 at the transmission rate TR2.

During the control term, the application module 26 of the sensor 3 turns off the corresponding electric equipment 20 based on the command content (=turning-off of gas) intended for the sensor 3. Then, during the data collection term, the application module 26 of the sensor 3 detects, by the detection element 28, data of the electric equipment 20 that have been turned off, at a sampling rate SR3. Then, the application module 26 of the sensor 3 periodically (=transmission period TT3) transmits the data detected by the detection element 28 to the control terminal 1 at transmission rate TR3.

Further, during the control term, the application module 26 of the sensor 4 continuously controls the temperature of the corresponding electric equipment 20 based on the command content (=continuous control of temperature) intended for the sensor 4. Then, during the data collection term, the application module 26 of the sensor 4 detects, by the detection element 28, data of the electric equipment 20 whose temperature has been continuously controlled, at a sampling rate SR4. Then, the application module 26 of the sensor 4 periodically (=transmission period TT4) transmits the data detected by the detection element 28 to the control terminal 1 at the transmission rate TR4.

Further, during the control term, the application module 26 of the sensor 5 turns off the corresponding electric equipment 20 based on the command content (=turning-off of water current) intended for the sensor 5. Then, during the data collection term, the application module 26 of the sensor 5 detects, by the detection element 28, data of the electric equipment 20 that has been turned off, at a sampling rate SR5. Then, the application module 26 of the sensor 5 periodically (=transmission period TT5) transmits the data detected by the detection element 28 to the control terminal 1 at the transmission rate TR5.

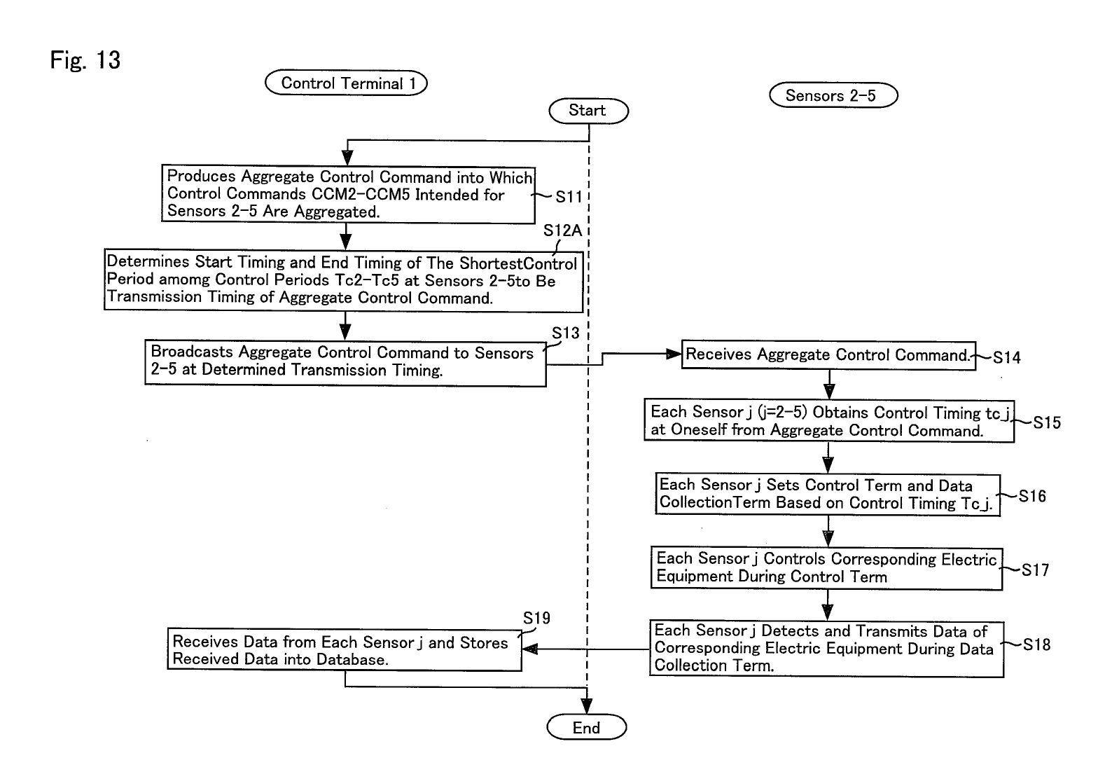

FIG. 13 is a flowchart to explain the operations using the control method MTH2 according to Embodiment 1.

The flowchart of FIG. 13 is identical with the flowchart of FIG. 11 except that Step S12 of the flowchart of FIG. 11 is replaced with Step S12A.

With reference to FIG. 13, after the above-described Step S11 is executed, the control management module 15 of the control terminal 1 determines the start timing and the end timing of the shortest control period among the control periods Tc2-Tc5 at the sensors 2-5 to be the transmission timing of the aggregate control commands (Step S12A).

Then, the above-described Step S13-Step S19 are sequentially executed, and the series of operations ends.

As described above, when the control method MTH2 is used, control commands intended for the sensors 2-5 are transmitted at a time to the sensors 2-5 at the start timing and the end timing of the shortest control period. As a result, the number of transmission of control commands decreases.

Therefore, the invention enables a narrow communication band. In addition, since time allocation for transmitting a control command is carried out within a fixed communication band, the control command is less likely to be subjected to packet loss etc. and is transmitted with higher reliability than data.

The sensors 2-5 extract, from the aggregate control commands CCM_AG, a control command (such as Add2/tc1_2, continuous control of current, SR2, TR2, and TT2) intended for oneself, controls the corresponding electric equipment 20 according to the extracted control command, and detects data of the corresponding electric equipment 20 to transmit to the control terminal 1.

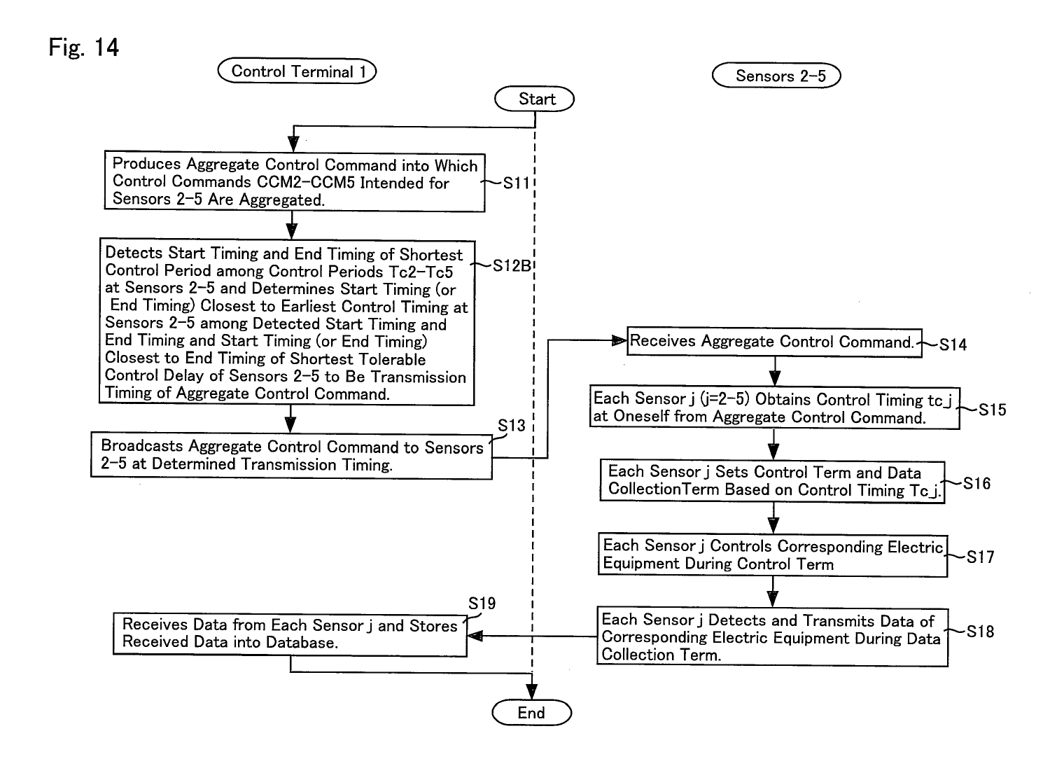

FIG. 14 is a flowchart to explain the operations using the control method MTH3 according to Embodiment 1.

The flowchart of FIG. 14 is identical with the flowchart of FIG. 13 except that Step S12A of the flowchart of FIG. 13 is replaced with Step S12B.

With reference to FIG. 14, after the above-described Step S11 is executed, the control management module 15 of the control terminal 1 detects the start timings and the end timings of the shortest control periods among the control periods Tc2-Tc5 of the sensors 2-5. Then, the control management module 15 of the control terminal 1 determines, among the start timings and the end timings, a start timing (or an end timing) closest to the earliest control timing at the sensors 2-5 and a start timing (or an end timing ) closest to the end timing of the shortest tolerable control delay of the sensors 2-5, to be the transmission timings of the aggregate control commands (Step S12B).

After that, the above-described Step S13-Step S19 are sequentially executed, and the series of operations ends.

As described above, when the control method MTH3 is used, control commands intended for the sensors 2-5 are transmitted at a time to the sensors 2-5 at the timings that synchronizes with the start timing or the end timing of the shortest control period and that is closest to the end timing of the shortest tolerable control delay among a plurality of tolerable control delays of the plurality of sensors 2-5. As a result, the number of transmission of control commands decreases.

Therefore, the invention enables a narrow communication band. In addition, since time allocation for transmitting a control command is carried out within a fixed communication band, the control command is less likely to be subjected to packet loss etc. and is transmitted with higher reliability than data.

The sensors 2-5 extracts, from the aggregate control commands CCM_AG, a control command (such as Add2/tc1_2, continuous control of current, SR2, TR2, and TT2) intended for oneself, controls the corresponding electric equipment 20 according to the extracted control command, and detects data of the corresponding electric equipment 20 to transmit to the control terminal 1.

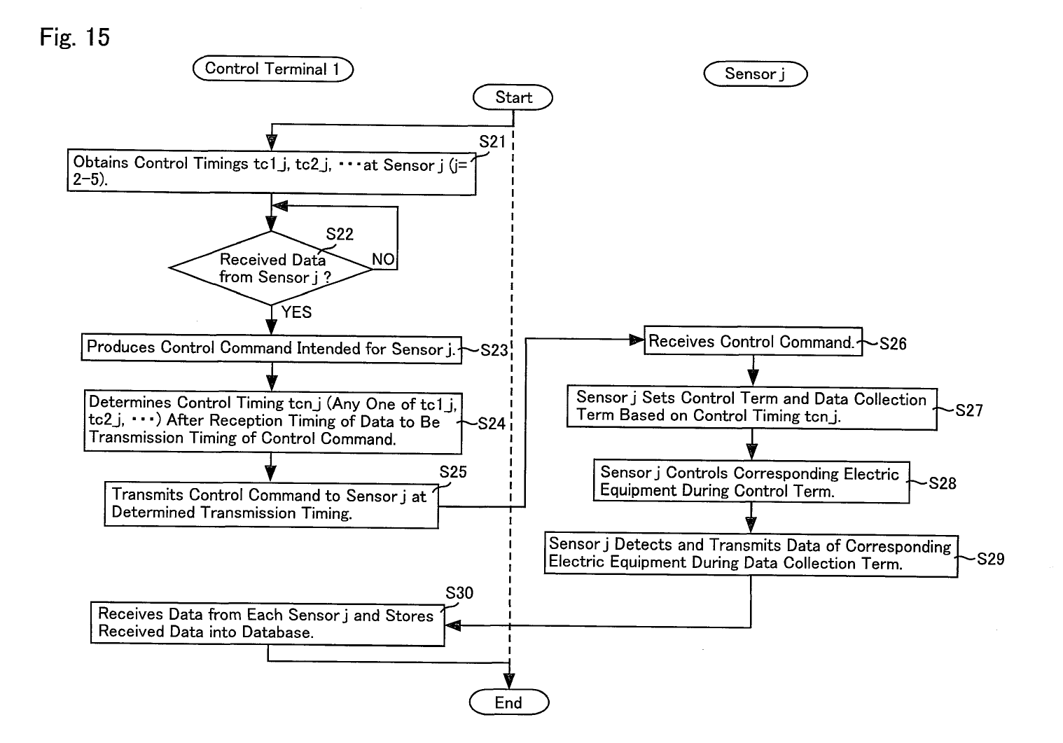

FIG. 15 is a flowchart to explain the operations using the control method MTH4 according to Embodiment 1.

With reference to FIG. 15, once a series of operations has started, the control management module 15 of the control terminal 1 obtains control timings tc1_{—}j, tc2_{—}j, . . . at the sensor j (Step S21).

After that, the application module 17 of the control terminal 1 determines whether data is received from the sensor j (Step S22), and upon receiving data from the sensor j, produces a control command intended for the sensor j (Step S23). Then, the application module 17 of the control terminal 1 outputs the produced control command to the data management module 14.

After that, the control management module 15 of the control terminal 1 determines the control timing tcn_j (any one of tc1_{—}j, tc2_{—}j, . . . ) after the reception timing of data to be the transmission timing of the control command (Step S24).

Then, the data management module 14 of the control terminal 1 transmits the control command produced by the application module 17 to the sensor j at the transmission timing determined by the control management module 15 (Step S25).

The sensor j receives the control command (Step S26). Then, the timing control module 25 of the sensor j sets a control term and a data collection term based on the control timing tcn_j included in the control command (Step S27).

Then, during the control term, the application module 26 of the sensor j controls the corresponding electric equipment 20 (Step S28).

During the data collection term, the application module 26 of the sensor j controls the detection element 28 so as to detect data representing the operating state of the corresponding electric equipment 20, and the detection element 28 detects data of the electric equipment 20 and outputs the data to the application module 26. Then, the application module 26 of the sensor j transmits the received data to the control terminal 1 (Step S29).

The application module 17 of the control terminal 1 receives data from each sensor j and stores the received data into the database 18 (Step S30), thereby ending the series of operations.

As described above, with the control method MTH4, the control terminal 1 transmits a control command to the sensor j only when data is received from the sensor j. Therefore, after transmitting a control command to the sensor j, if no data is received from the sensor j by the next transmission timing of the control command, transmission of the control command at said next transmission timing is stopped. As a result, the number of transmission of control commands decreases.

Therefore, the invention enables a narrow communication band. In addition, since time allocation for transmitting a control command is carried out within a fixed communication band, the control command is less likely to be subjected to packet loss etc. and is transmitted with higher reliability than data.

The sensor j that has received a control command controls the corresponding electric equipment 20 according to the control command by using the methods described above, and detects data of the corresponding electric equipment 20 to transmit to the control terminal 1.

Note that when the control method MTH1 is selected, the invention may transmit a control command to the sensor j by further applying the control method MTH4.

In this case, after receiving data from the sensors 2-5, the control terminal 1 transmits a plurality of control commands intended for the sensors 2-5 at a time to the sensors 2-5 at the earliest control timing or the latest control timing among a plurality of control timings at the sensors 2-5.

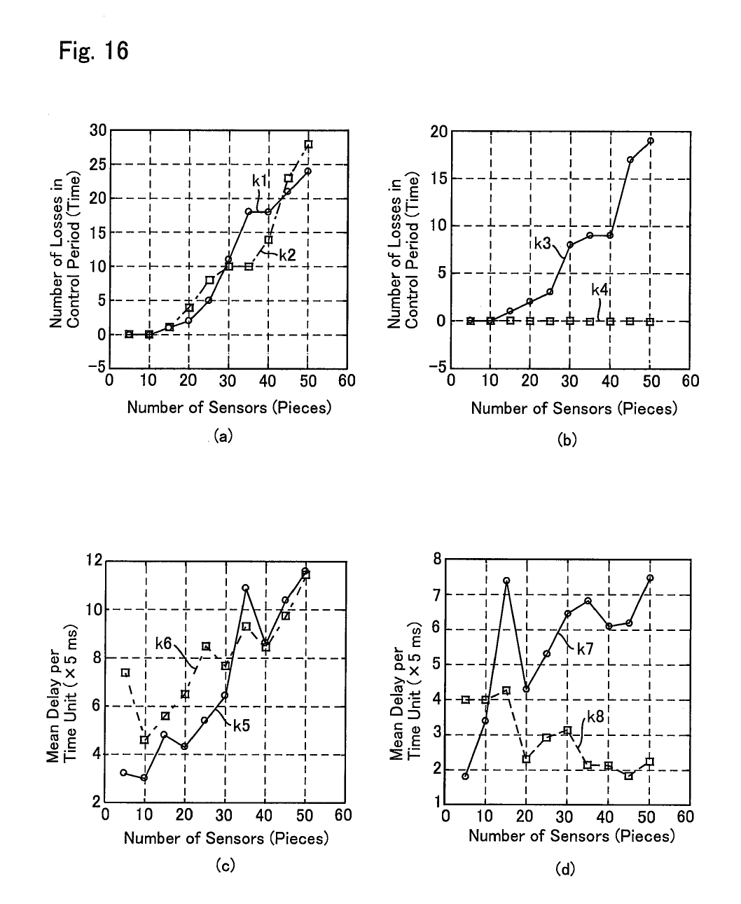

FIG. 16 illustrates a simulation outcome of the sensor network system 10 shown in FIG. 1.

Graph (a) of FIG. 16 illustrates a relationship between the number of packet losses in a control period and the number of sensors observed when a conventional communication method is used. Graph (b) of FIG. 16 illustrates a relationship between the number of packet losses in a control period and the number of sensors observed when a communication method according to the invention is used. Graph (c) of FIG. 16 illustrates a relationship between the mean delay per time unit and the number of sensors observed when a conventional communication method is used. Graph (d) of FIG. 16 illustrates a relationship between the mean delay per time unit and the number of sensors observed when a communication method according to the invention is used.

Here, the conventional communication method is the method of CSMA (Carrier Sense Multiple Access).

In (a) and (b) of FIG. 16, the vertical axis represents the number of packet losses observed during a control period, and the abscissa axis represents the number of sensors. Curves k1 and k3 represent relationships between the number of losses of packets including detection data detected by the sensors 2-5 and the number of sensors, and curves k2 and k4 represent relationships between the number of losses of packets including a control command and the number of sensors.

In (c) and (d) of FIG. 16, the vertical axis represents the mean delay per time unit, and the abscissa axis represents the number of sensors. Curves k5 and k7 represent relationships between the mean delay of packets including detection data detected by the sensors 2-5 and the number of sensors, and curves k6 and k8 represent relationships between the mean delay of packets including a control command and the number of sensors.

Here, since one time unit is 5 ms, the mean delay values are obtained by multiplying the values along the vertical axis of the (c) and (d) of FIG. 16 by 5 ms.

With reference to (a) of FIG. 16, when a conventional communication method is used, the number of losses of packets including detection data and that of packets including a control command increase as the number of sensors increases (refer to curves k1 and k2).

With reference to (b) of FIG. 16, when a communication method according to the invention is used, the number of losses of packets including detection data increases as the number of sensors increases (refer to curve k3), however, the number of losses of packets including a control command almost remains zero, despite an increase in the number of sensors (refer to curve k4). This is because when a communication method according to the invention is used, the number of transmission of control commands decreases, and therefore, losses of packets including a control command are less likely to occur.

With reference to (c) of FIG. 16, when a conventional communication method is used, the mean delay of packets including detection data and that of packets including a control command increase as the number of sensors increases (refer to curves k5 and k6).

With reference to (d) of FIG. 16, the mean delay of packets including detection data increases as the number of sensors increases (refer to curve k7), however, the mean delay of packets including a control command decreases as the number of sensors increases (refer to curve k8). When the control methods MTH1-MTH3 are used, a plurality of control commands are transmitted at a time to a plurality of sensors, and therefore, the transmission interval of the plurality of control commands increases as the number of sensors increases. As a result, the number of transmission of control commands per unit time decreases as the number of sensors increases, and retransmission of packets including a plurality of control commands is less likely to occur. When the control method MTH4 is used, the control terminal 1 transmits a control command to the sensors 2-5 when detection data is received from the sensors 2-5. As a result, same as the above-mentioned, the number of transmission of control commands per unit time decreases as the number of sensors increases, and retransmission of packets including a control command is less likely to occur. Therefore, it is understood that the mean delay decreases as the number of sensors increases.

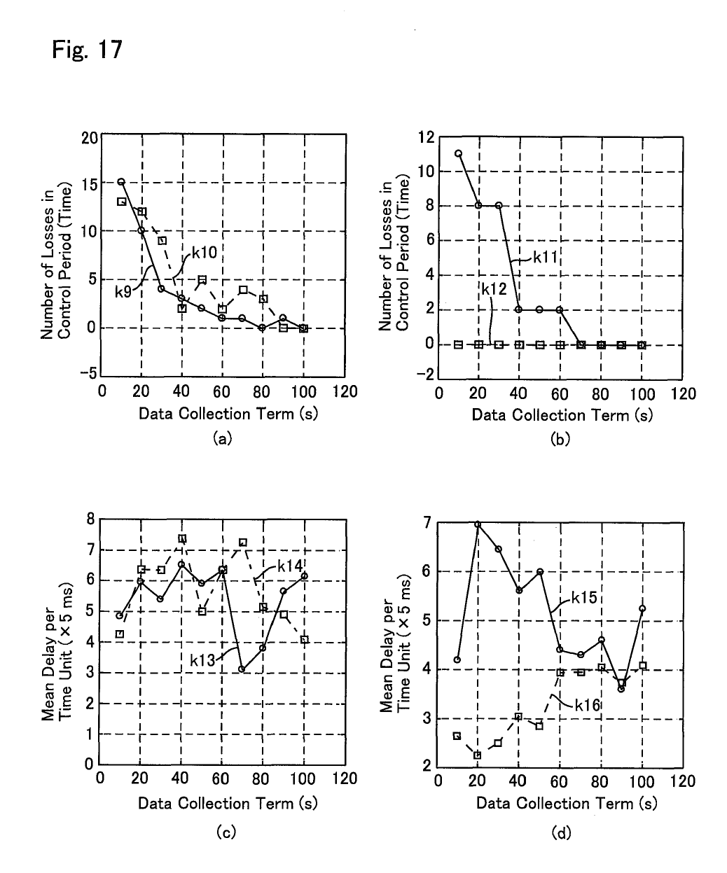

FIG. 17 illustrates another simulation outcome of the sensor network system 10 shown in FIG. 1.

Graph (a) of FIG. 17 illustrates a relationship between the number of packet losses in a control period and a data collection term observed when a conventional communication method is used. Graph (b) of FIG. 17 illustrates a relationship between the number of packet losses in a control period and a data collection term observed when a communication method according to the invention is used. Graph (c) of FIG. 17 illustrates a relationship between the mean delay per time unit and a data collection term observed when a conventional communication method is used. Graph (d) of FIG. 17 illustrates a relationship between the mean delay per time unit and a data collection term observed when the communication method according to the invention is used.

In (a) and (b) of FIG. 17, the vertical axis represents the number of packet losses in a control period, and the abscissa axis represents a data collection term. Curves k9 and k11 represent relationships between the number of losses of packets including detection data detected by the sensors 2-5 and a data collection term, and curves k10 and k12 represent relationships between the number of losses of packets including a control command and a data collection term.

In (c) and (d) of FIG. 17, the vertical axis represents the mean delay per time unit, and the abscissa axis represents a data collection term. Curves k13 and k15 represent relationships between the mean delay of packets including detection data detected by the sensors 2-5 and a data collection term, and curves k14 and k16 represent relationships between the mean delay of packets including a control command and a data collection term.

With reference to (a) of FIG. 17, when a conventional communication method is used, the number of losses of packets including detection data and that of packets including a control command decrease as the data collection term increases (refer to curves k9 and k10). While the transmission timings of packets including detection data, from the sensors 2-5 to the control terminal 1, scatter as the data collection term increases, the transmission intervals of packets including a control command increases as the data collection term increases. As a result, it is understood that the number of losses of packets including detection data and that of packets including a control command decrease as the data collection term increases.

With reference to (b) of FIG. 17, when a communication method according to the invention is used, the number of losses of packets including detection data decreases as the data collection term increases (refer to curve k11), however, the number of losses of packets including a control command almost remains zero as the data collection term increases(refer to curve k12).

It is understood that when a communication method according to the invention is used, the number of transmission of control commands decreases, and therefore, losses of packets including a control command are less likely to occur.

With reference to (c) of FIG. 17, when a conventional communication method is used, the mean delay of packets including detection data and that of packets including a control command randomly scatter with respect to the data collection term (refer to curves k13 and k14).

With reference to (d) of FIG. 17, when a communication method according to the invention is used, the mean delay of packets including detection data can exceed 25 ms, which is the target value of control command delay, with respect to the data collection term (refer to curve k15), however, the mean delay of packets including a control command is shorter than the target value of 25 ms with respect to the data collection term (refer to curve k16). When the control methods MTH1-MTH3 are used, a plurality of control commands are transmitted at a time to a plurality of sensors, and therefore, the transmission interval of the plurality of control commands increases as the data collection term increases. As a result, the number of transmission of control commands per unit time decreases as the data collection term increases, and therefore, retransmission of packets including a plurality of control commands is less likely to occur. When the control method MTH4 is used, the control terminal 1 transmits a control command to the sensors 2-5 when detection data is received from the sensors 2-5. As a result, same as the above-described, the number of transmission of control commands per unit time decreases as the data collection term increases, and therefore, retransmission of packets including a control command is less likely to occur. Therefore, it is understood that the mean delay of packets including a control command decreases as the number of sensors increases.

As described above, it has been demonstrated that a control command is transmitted with higher reliability than data by using a communication method according to the invention.

### Embodiment 2

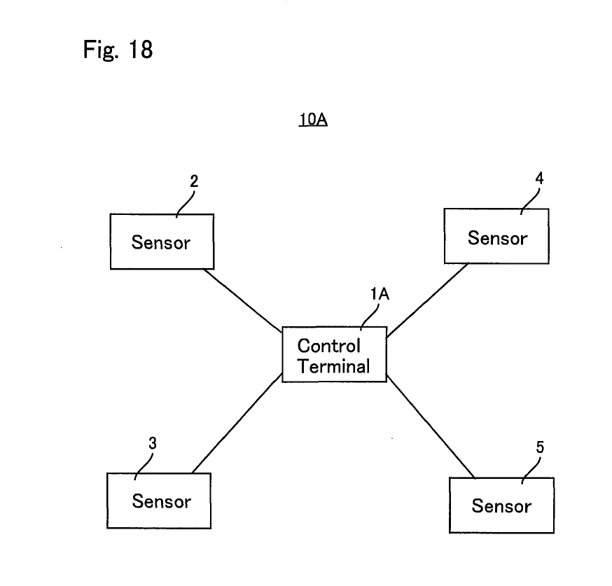

FIG. 18 is a schematic view of a sensor network system according to Embodiment 2. With reference to FIG. 18, a sensor network system 10A according to Embodiment 2 is identical with the sensor network system 10 shown in FIG. 1 except that the control terminal 1 of the sensor network system 10 is replaced with a control terminal 1A.

Note that in Embodiment 2, some packets including a control command as data have a data size of 100 bytes or less, and others have a data size larger than 100 bytes.

If the data size Ds of a packet including a control command is larger than a standard value Ds_std, the control terminal 1A transmits a control command to the sensors 2-5 by including the control command in a plurality of packets each having a data size of the standard value Ds_std or less.

In this case, a packet including a control command is transmitted to the sensors 2-5 by using any one of the above-described control methods MTH1-MTH4. The standard value Ds_std is set to 100 bytes, for example.

Other than that, the control terminal 1A functions the same way as the control terminal 1.

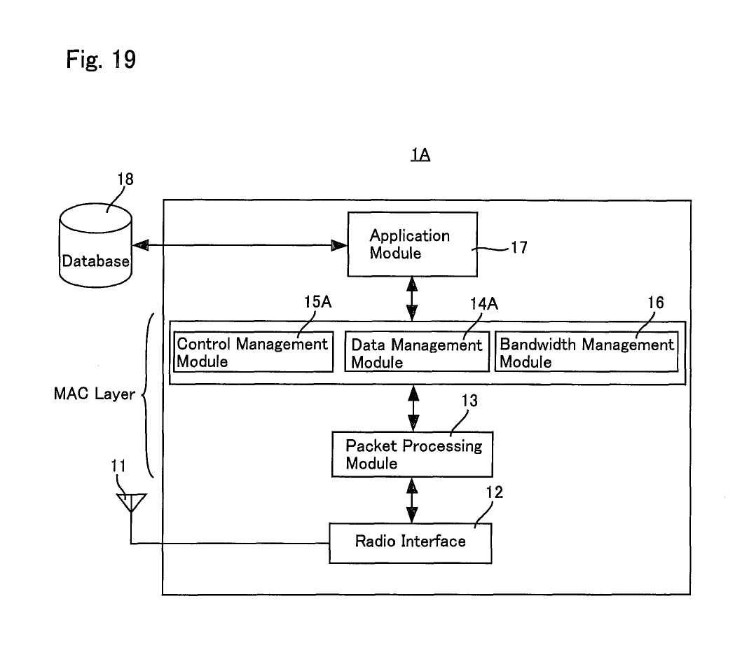

FIG. 19 is a schematic block diagram illustrating the configuration of the control terminal 1A of FIG. 18. With reference to FIG. 19, the control terminal 1A is identical with the control terminal 1 shown in FIG. 2 except that the data management module 14 of the control terminal 1 is replaced with the data management module 14A, and the control management module 15 with the control management module 15A.

Upon receiving a plurality of control commands from the application module 17 and any one of the control methods MTH1-MTH3 from the bandwidth management module 16, the data management module 14A calculates the total data size Ds_all of all of the plurality of control commands and calculates K1=int(Ds_all/Ds_std)+1. Then, the data management module 14A outputs the calculated K1 to the control management module 15A.

The data management module 14A also compares the data size Ds_all with the standard value Ds_std, and if the data size Ds_all is larger than the standard value Ds_std (that is to say, if K1 is 2 or larger), produces a plurality of packets including a plurality of control commands using the methods described below and transmits the produced plurality of packets to the sensors 2-5 at a transmission timing received from the control management module 16A. Thereafter, the data management module 14A transmits a plurality of packets to the sensors 2-5 upon each reception of a transmission timing from the control management module 15A.

On the other hand, if the data size Ds_all is equal to the standard value Ds_std or less (that is to say, if K1 is 1), the data management module 14A produces a packet including a plurality of control commands and transmits the produced packet to the sensors 2-5 at a transmission timing received from the control management module 15A. Thereafter, the data management module 14A transmits a packet to the sensors 2-5 upon each reception of a transmission timing from the control management module 15A.

Upon receiving the control method MTH4 from the bandwidth management module 16 and a control command from the application module 17, the data management module 14A detects the data size Ds of the control command and calculates K2=int(Ds/Ds_std)+1. Then, the data management module 14A outputs the calculated K2 to the control management module 15A.

The data management module 14A also compares the data size Ds with the standard value Ds_std, and if the data size Ds is larger than the standard value Ds_std (that is to say, K2 is 2 or larger) produces a plurality of packets including a control command using the methods described below and transmits the produced plurality of packets to the sensor j at a transmission timing received from the control management module 15A. Thereafter, the data management module 14A transmits a plurality of packets to the sensor j upon each reception of a transmission timing from the control management module 15A.

On the other hand, if the data size Ds is equal to the standard value Ds_std or less (that is to say, if K2 is 1), the data management module 14A produces a packet including a control command and transmits the produced packet to the sensor j at a transmission timing received from the control management module 15A. Thereafter, the data management module 14A transmits a packet to the sensor j upon each reception of a transmission timing from the control management module 16A.

Other than that, the data management module 14A functions the same way as the data management module 14.

The control management module 15A receives K1 and K2 from the data management module 14A. Then, if K1 or K2 is 2 or larger, the control management module 15A determines a transmission timing for transmitting a plurality of packets including a plurality of control commands or a control command using the methods described below and outputs the determined transmission timing to the data management module 14A.

If K1 or K2 is 1, the control management module 15A determines a transmission timing for transmitting a packet including a plurality of control commands or a control command using the same method as that used in Embodiment 1 and outputs the determined transmission timing to the data management module 14A.

Other than that, the control management module 15A functions the same way as the control management module 15.

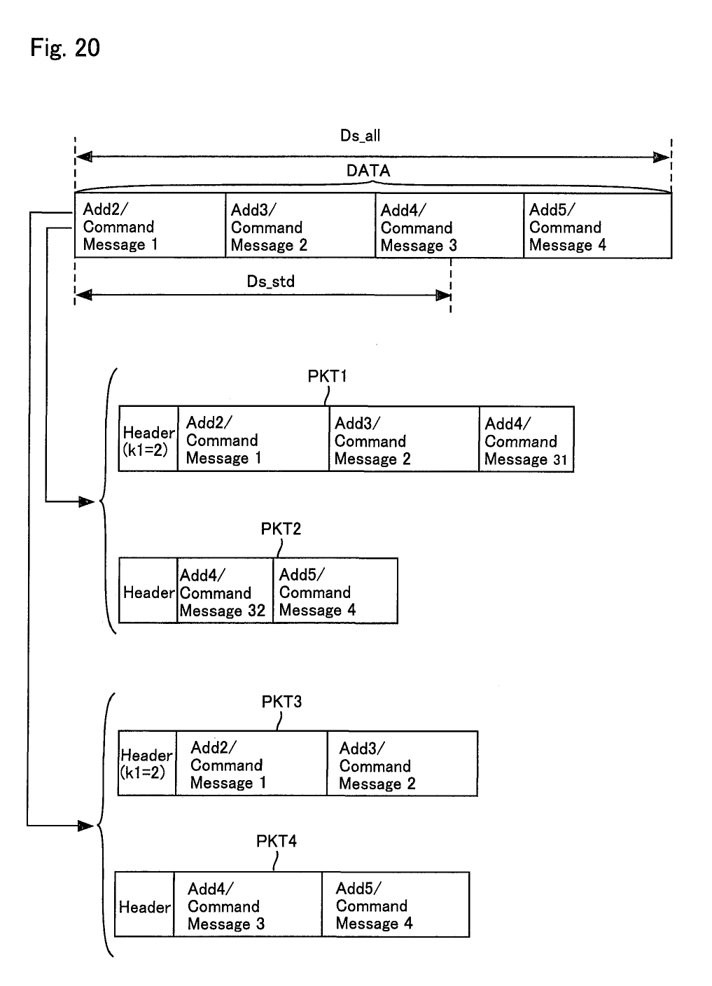

Now, how to produce a plurality of packets including a plurality of control commands will be described. FIG. 20 is a figure to explain a method of producing a plurality of packets including a plurality of control commands.

With reference to FIG. 20, upon receiving, from the application module 17, command messages 1-4 to be transmitted to the sensors 2-5, the data management module 14A of the control terminal 1A calculates the total data size Ds_all of all of the Add2/Command Message 1, Add3/Command Message 2, Add4/Command Message 3, and Add5/Command Message 4.

Then, the data management module 14A calculates K1=int(Ds_all/Ds_std)+1=2 and detects that the calculated K1 is 2. After that, the data management module 14A counts 100 bits (=the standard value Ds_std) from the beginning of the Add2/Command Message 1, and detects that the 100th bit (=the standard value Ds_std) from the beginning of the Add2/Command Message 1 is in the middle of the Add4/Command Message 3.

Then, the data management module 14A divides the Add4/Command Message 3 into Add4/Command Message 31 and Add4/Command Message 32 at a bit in the Add4/Command Message 3, which is the 100th bit (=the standard value Ds_std) from the beginning of the Add2/Command Message 1.

Then, the data management module 14A produces a packet PKT1 by storing the Add2/Command Message 1|Add3/Command Message 2|Add4/Command Message 31 into the data portion and adding a header including K1=2, and produces a packet PKT2 by storing the Add4/Command Message 32|Add5/Command Message 4 into the data portion and adding a header.

Note that K1=2 is included only into the packet PKT1, between the packets PKT1 and PKT2, in order to notify the sensors 2-5 that a plurality of control commands are to be transmitted with a plurality of packets, by including K1=2 into the packet PKT1 that is the first to be transmitted to the sensors 2-5.

The data management module 14A may produce a plurality of packets including a plurality of control commands using the method described below.

Upon detecting that the 100th bit (=the standard value Ds_std) from the beginning of the Add2/Command Message 1 is in the middle of Add4/Command Message 3, the data management module 14A divides the Add2/Command Message 1|Add3/Command Message 2|Add4/Command Message 3|Add5/Command Message 4 into Add2/Command Message 1|Add3/Command Message 2 and Add4/Command Message 3|Add5/Command Message 4.

Then, the data management module 14A produces a packet PKT3 by storing the Add2/Command Message 1|Add3/Command Message 2 into the data portion and adding a header including K1=2, and produces a packet PKT4 by storing the Add4/Command Message 3|Add5/Command Message 4 into the data portion and adding a header.

Note that K1=2 is included only into the packet PKT3, between the packets PKT3 and PKT4, for the same reason that K1=2 is included only into the packet PKT1, between the packets PKT1 and PKT2.

As described above, if the data size Ds_all is larger than the standard value Ds_std, the data management module 14A produces a plurality of packets including a plurality of control commands by using either one of the above-described two methods.

Note that when the sensors 2-5 have received the packets PKT1 and PKT2 from the control terminal 1A, the application module 26 of the sensor 2 extracts the command message 1 from the packet PKT1 as a control command intended for the sensor 2, and the application module 26 of the sensor 3 extracts the command message 2 from the packet PKT1 as a control command intended fro the sensor 3.

Likewise, the application module 26 of the sensor 4 extracts the command message 31 from the packet PKT1 and the command message 32 from the packet PKT2 and obtains the command message 3 by connecting the extracted command message 32 to the end of the command message 31.

Further, the application module 26 of the sensor 5 extracts the command message 4 from the packet PKT2 as a control command intended for the sensor 5.

On the other hand, when the sensors 2-5 have received the packets PKT3 and PKT4 from the control terminal 1A, the application module 26 of the sensor 2 extracts the command message 1 from the packet PKT3 as a control command intended for the sensor 2, and the application module 26 of the sensor 3 extracts the command message 2 from the packet PKT3 as a control command intended for the sensor 3. The application module 26 of the sensor 4 extracts the command message 3 from the packet PKT4 as a control command intended for the sensor 4, and the application module 26 of the sensor 5 extracts the command message 4 from the packet PKT4 as a control command intended for the sensor 5.

Further, if the data size Ds_all is 200 bytes or larger, the data management module 14A divides the Add2/Command Message 1|Add3/Command Message 2|Add4/Command Message 3|Add5/Command Message 4, by every standard value Ds_std (=100 bytes) from the beginning, into three parts or more. Then, the data management module 14A produces three packets or more respectively including one of the three parts or more in the data portion.

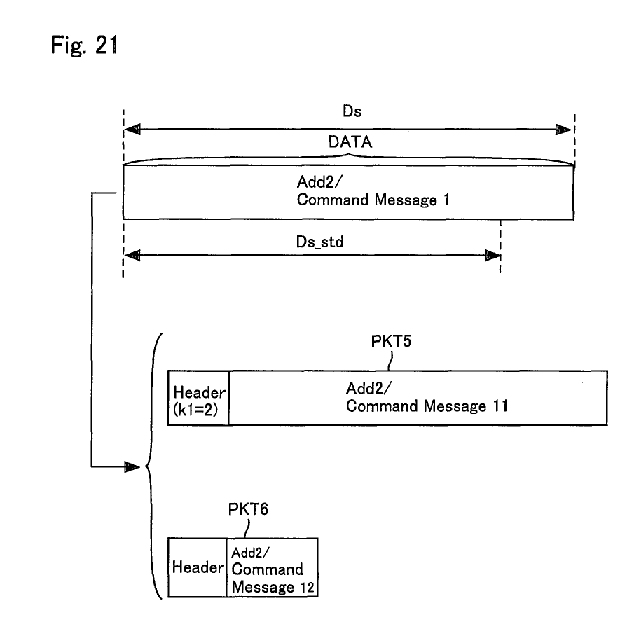

FIG. 21 is to explain another method of producing a plurality of packets including a plurality of control commands.

With reference to FIG. 21, upon receiving, from the application module 17, the command message 1 to be transmitted to the sensor 2, for example, the data management module 14A of the control terminal 1A detects the data size Ds of the command message 1 and calculates K2=int(Ds/Ds_std)+1=2. Then, the data management module 14A detects that the calculated K2 is 2, counts 100 bits (=the standard value Ds_std) from the beginning of the Add2/Command Message 1, and detects that the 100th bit (=the standard value Ds_std) from the beginning of the Add2/Command Message 1 is in the middle of the Add2/Command Message 1.

Then, the data management module 14A divides the Add2/Command Message 1 into Add2/Command Message 11 and Add2/Command Message 12 at a bit of the Add2/Command Message 1, which is the 100th bit (=the standard value Ds_std) from the beginning of the Add2/Command Message 1.

Then, the data management module 14A produces a packet PKT5 by storing the Add2/Command Message 11 into the data portion and adding a header including K2=2, and a packet PKT6 by storing the Add2/Command Message 12 into the data portion and adding a header.

Note that K2=2 is included only into the packet PKT5, between the packets PKT5 and PKT6, for the same reason that K1=2 is included only into the packet PKT1, between the packets PKT1 and PKT2.

When the sensor 2 has received the packets PKT5 and PKT6 from the control terminal 1A, the application module 26 of the sensor 2 extracts the command message 11 from the packet PKT5 and the command message 12 from the packet PKT6 and obtains the command message 1 by connecting the extracted command message 12 to the end of the command message 11.

When the command messages 2-4 other than the command message 1 are transmitted, the packets PKT5 and PKT6 are also produced by using the methods described above.

If the data size Ds is larger than 200 bytes, the data management module 14A divides the Add2/Command Message 1, by every standard value Ds_std (=100 bytes) from the beginning, into three parts or more. Then, the data management module 14A produces three packets or more respectively including one of the three parts or more in the data portion.

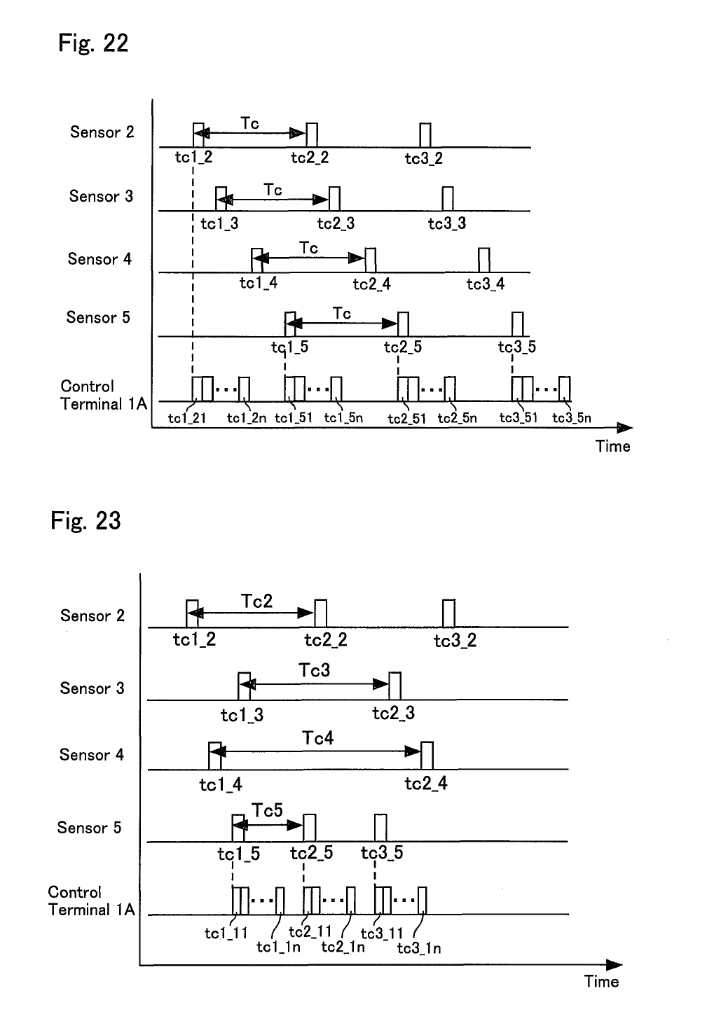

FIG. 22 is a timing chart illustrating transmission timings of a control command according to Embodiment 2.

With reference to FIG. 22, the control management module 15A of the control terminal 1A receives K1 or K2 from the data management module 14A and the control method MTH1 from the bandwidth management module 16. Then, if K1 or K2 is 1, the control management module 15A determines transmission timings tc1_21, tc1_51, tc2_51, and tc3_51 of a control command by using the methods described with respect to Embodiment 1 and sequentially outputs the determined transmission timings tc1_21, tc1_51, tc2_51, and tc3_51 to the data management module 14A. Note that the transmission timings tc1_21, tc1_51, tc2_51, and tc3_51 are respectively equal to the transmission timings tc1_2, tc1_5, tc2_5, and tc3_5 shown in FIG. 4.

On the other hand, if K1 or K2 is 2 or larger, the control management module 15A determines transmission timings tc1_21, tc1_51, tc2_51, and tc3_51 of a control command by using the methods described with respect to Embodiment 1. Then, the control management module 15A determines transmission timings tc1_22-tc1_2n (n=K1 or K2) successively to the transmission timing tc1_21. The control management module 15A also determines transmission timings tc1_52-tc1_5n successively to the transmission timing tc1_51. Thereafter, the control management module 15A determines, in the same manner, transmission timings tc2_52-tc2_5n successively to the transmission timing tc2_51, and transmission timings tc3_52-tc3_5n successively to the transmission timing tc3_51.

Then, the control management module 15A outputs the transmission timings tc1_21-tc1_2n to the data management module 14A, and after that, the transmission timings tc1_51-tc1_5n to the data management module 14A, and after that, the transmission timings tc2_51-tc2_5n to the data management module 14A, and after that, the transmission timings tc3_51-tc3_5n to the data management module 14A.

FIG. 23 is a timing chart illustrating other transmission timings of a control command according to Embodiment 2.

With reference to FIG. 23, the control management module 15A of the control terminal 1A receives K1 or K2 from the data management module 14A and the control method MTH2 from the bandwidth management module 16. Then, if K1 or K2 is 1, the control management module 15A determines transmission timings tc1_11, tc2_11, and tc3_11 of a control command by using the methods described with respect to Embodiment 1 and sequentially outputs the determined transmission timings tc1_11, tc2_11, and tc3_11 to the data management module 14A. Note that the transmission timings tc1_11, tc2_11, and tc3_11 are respectively equal to the transmission timings tc1_1, tc2_1, and tc3_1 shown in FIG. 5.

On the other hand, if K1 or K2 is 2 or larger, the control management module 15A determines the transmission timings tc1_11, tc2_11, and tc3_11 of a control command by using the methods described with respect to Embodiment 1. Then, the control management module 15A determines transmission timings tc1_12-tc1_1n successively to the transmission timing tc1_11. The control management module 15A also determines transmission timings tc2_12-tc2_1n successively to the transmission timing tc2_11. Thereafter, the control management module 15A determines, in the same manner, transmission timings tc3_12-tc3_1n successively to the transmission timing tc3_11.

Then, the control management module 15A outputs the transmission timings tc1_11-tc1_1n to the data management module 14A, and after that, the transmission timings tc2_11-tc2_1n to the data management module 14A, and after that, the transmission timings tc3_11-tc3_1n to the data management module 14A.

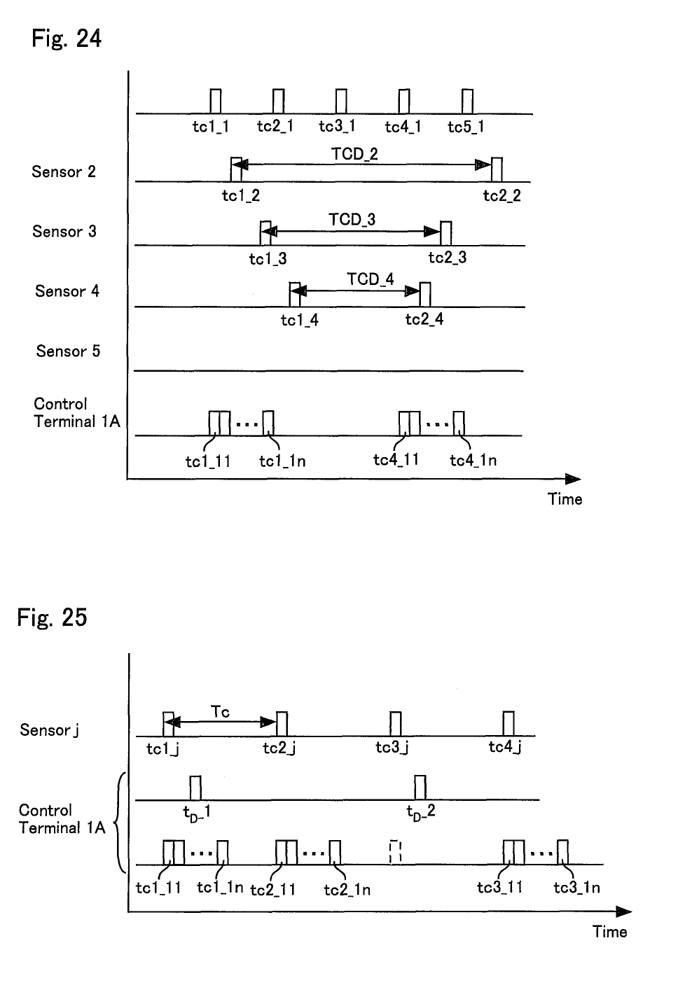

FIG. 24 is a timing chart illustrating other transmission timings of a control command according to Embodiment 2.

With reference to FIG. 24, the control management module 15A of the control terminal 1A receives K1 or K2 from the data management module 14A and the control method MTH3 from the bandwidth management module 16. Then, if K1 or K2 is 1, the control management module 15A determines the transmission timings tc1_11 and tc4_11 of a control command by using the methods described with respect to Embodiment 1 and sequentially outputs the determined transmission timings tc1_11 and tc4_11 to the data management module 14A. Note that the transmission timings tc1_11 and tc4_11 are respectively equal to the transmission timings tc1_1 and tc4_1 shown in FIG. 6.

On the other hand, if K1 or K2 is 2 or larger, the control management module 15A determines the transmission timings tc1_11 and tc4_11 of a control command by using the methods described with respect to Embodiment 1. Then, the control management module 15A determines the transmission timings tc1_12-tc1_1n successively to the transmission timing tc1_11. The control management module 15A also determines the transmission timings tc4_12-tc4_1n successively to the transmission timing tc4_11.

Then, the control management module 15A outputs the transmission timings tc1_11-tc1_1n to the data management module 14A, and after that, the transmission timings tc4_11-tc4_1n to the data management module 14A.

FIG. 25 is a timing chart illustrating other transmission timings of a control command according to Embodiment 2.

With reference to FIG. 25, the control management module 15A of the control terminal 1A receives K1 or K2 from the data management module 14A and the control method MTH4 from the bandwidth management module 16. Then, if K1 or K2 is 1, the control management module 15A determines the transmission timings tc1_11, tc2_11, and tc3_11 of a control command by using the methods described with respect to Embodiment 1 and sequentially outputs the determined transmission timings tc1_11, tc2_11, and tc3_11 to the data management module 14A. Note that the transmission timings tc1_11, tc2_11, and tc3_11 are respectively equal to the transmission timings tc1_1, tc2_1, and tc3_1 shown in FIG. 7.

On the other hand, if K1 or K2 is 2 or larger, the control management module 15A determines the transmission timings tc1_11, tc2_11, and tc3_11 of a control command by using the methods described with respect to Embodiment 1. Then, the control management module 15A determines the transmission timings tc1_12-tc1_1n successively to the transmission timing tc1_11. The control management module 15A also determines the transmission timings tc2_12-tc2_1n successively to the transmission timing tc2_11. Further, the control management module 15A determines the transmission timings tc3_2-tc3_1n successively to the transmission timing tc3_11.

Then, the control management module 15A outputs the transmission timings tc1_11-tc1_1n to the data management module 14A, and after that, the transmission timings tc2_11-tc2_1n to the data management module 14A, and after that, the transmission timings tc3_11-tc3_1n to the data management module 14A.

If K1 or K2 is 1, upon receiving the control method MTH1 from the bandwidth management module 16 and the transmission timing tc1_21 from the control management module 15A, the data management module 14A of the control terminal 1A transmits, to the sensors 2-5, a packet including a plurality of control commands at the transmission timing tc1_21. After that, upon receiving the transmission timing tc1_51 from the control management module 15A, the data management module 14A transmits a packet to the sensors 2-5 at the transmission timing tc1_51, and upon receiving the transmission timing tc2_51 from the control management module 15A, transmits a packet to the sensors 2-5 at the transmission timing tc2_51, and upon receiving the transmission timing tc3_51 from the control management module 15A, transmits a packet to the sensors 2-5 at the transmission timing tc3_51 (refer to FIG. 22).

If K1 or K2 is 2 or larger, upon receiving the control method MTH1 from the bandwidth management module 16 and the transmission timings tc1_21-tc1_2n from the control management module 15A, the data management module 14A of the control terminal 1A transmits, to the sensors 2-5, a plurality of packets PKT1-PKTn including a plurality of control commands produced by using the methods described above, respectively at the transmission timings tc1_21-tc1_2n. After that, upon receiving the transmission timings tc1_51-tc1_5n from the control management module 15A, the data management module 14A transmits the packet PKT1-PKTn to the sensors 2-5 respectively at the transmission timings tc1_51-tc1_5n, and upon receiving the transmission timings tc2_51-tc2_5n from the control management module 15A, transmits the packets PKT1-PKTn to the sensors 2-5 respectively at the transmission timings tc2_51-tc2_5n, and upon receiving the transmission timings tc3_51-tc3_5n from the control management module 15A, transmits the packets PKT1-PKTn to the sensors 2-5 respectively at the transmission timings tc3_51-tc3_5n (refer to FIG. 22).

Further, if K1 or K2 is 1, upon receiving the control method MTH2 from the bandwidth management module 16 and the transmission timing tc1_11 from the control management module 15A, the data management module 14A of the control terminal 1A transmits a packet including a plurality of control commands to the sensors 2-5 at the transmission timing tc1_11. After that, upon receiving the transmission timing tc2_11 from the control management module 15A, the data management module 14A transmits a packet to the sensors 2-5 at the transmission timing tc2_11, and upon receiving the transmission timing tc3_11 from the control management module 15A, transmits a packet to the sensors 2-5 at the transmission timing tc3_11 (refer to FIG. 23).

Further, if K1 or K2 is 2 or larger, upon receiving the control method MTH2 from the bandwidth management module 16 and the transmission timings tc1_11-tc1_1n from the control management module 15A, the data management module 14A of the control terminal 1A transmits, to the sensors 2-5, a plurality of packets PKT1-PKTn including a plurality of control commands produced by using the methods described above, respectively at the transmission timings tc1_11-tc1_1n. After that, upon receiving the transmission timings tc2_11-tc2_1n from the control management module 15A, the data management module 14A transmits the packets PKT1-PKTn to the sensors 2-5 respectively at the transmission timings tc2_11-tc2_1n, and upon receiving the transmission timings tc3_11-tc3_1n from the control management module 15A, transmits the packets PKT1-PKTn to the sensors 2-5 respectively at the transmission timings tc3_11-tc3_1n (refer to FIG. 23).

Further, if K1 or K2 is 1, upon receiving the control method MTH3 from the bandwidth management module 16 and the transmission timing tc1_11 from the control management module 15A, the data management module 14A of the control terminal 1A transmits a packet including a plurality of control commands to the sensors 2-5 at the transmission timing tc1_11. After that, upon receiving the transmission timing tc4_11 from the control management module 15A, the data management module 14A transmits a packet to the sensors 2-5 at the transmission timing tc4_11 (refer to FIG. 24).

Further, if K1 or K2 is 2 or larger, upon receiving the control method MTH3 from the bandwidth management module 16 and the transmission timings tc1_11-tc1_1n from the control management module 15A, the data management module 14A of the control terminal 1A transmits, to the sensors 2-5, a plurality of packets PKT1-PKTn including a plurality of control commands produced by using the methods described above, respectively at the transmission timings tc1_11-tc1_1n. After that, upon receiving the transmission timings tc4_11-tc4_1n from the control management module 15A, the data management module 14A transmits the packets PKT1-PKTn to the sensors 2-5 respectively at the transmission timings tc4_11-tc4_1n (refer to FIG. 24).

Further, if K1 or K2 is 1, upon receiving the control method MTH4 from the bandwidth management module 16 and the transmission timing tc1_11 from the control management module 15A, the data management module 14A of the control terminal 1A transmits a packet including a control command to the sensor j at the transmission timing tc1_11. After that, upon receiving the transmission timing tc2_11 from the control management module 15A, the data management module 14A transmits a packet to the sensor j at the transmission timing tc2_11, and upon receiving the transmission timing tc3_11 from the control management module 15A, transmits a packet to the sensor j at the transmission timing tc3_11 (refer to FIG. 25).

Further, if K1 or K2 is 2 or larger, upon receiving the control method MTH4 from the bandwidth management module 16 and the transmission timings tc1_11-tc1_1n from the control management module 15A, the data management module 14A of the control terminal 1A transmits, to the sensor j, a plurality of packets PKT1-PKTn including a control command produced by using the methods described above, respectively at the transmission timings tc1_11-tc1_1n. After that, upon receiving the transmission timings tc2_11-tc2_1n from the control management module 15A, the data management module 14A transmits packets PKT1-PKTn to the sensor j respectively at the transmission timings tc2_11-tc2_1n, and upon receiving the transmission timings tc3_11-tc3_1n from the control management module 15A, transmits packets PKT1-PKTn to the sensor j respectively at the transmission timings tc3_11-tc3_1n.

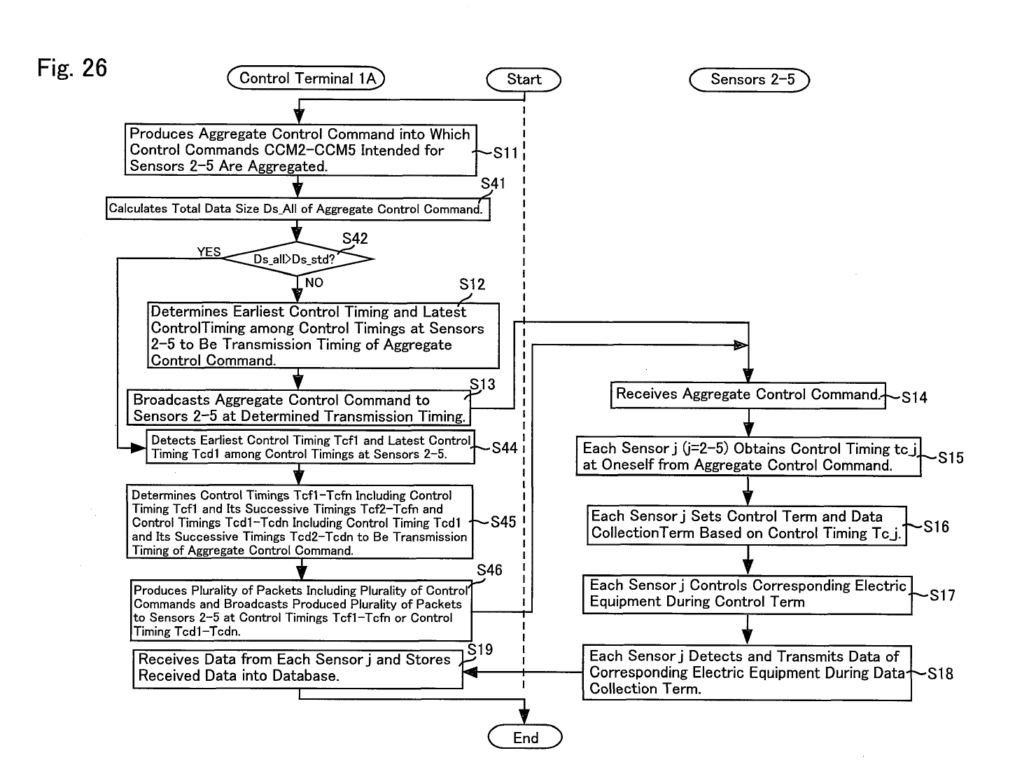

FIG. 26 is a flowchart to explain the operations using the control method MTH1 according to the Embodiment 2.

The flowchart shown in FIG. 26 is identical with the flowchart shown in FIG. 11 except that Steps S41 and S42 are inserted between Step S11 and Step S12 of the flowchart shown in FIG. 11 and Steps S44-S46 are added.

With reference to FIG. 26, after Step S11, the data management module 14A of the control terminal 1A calculates the total data size Ds_all of the aggregate control commands (Step S41) and determines whether the calculated data size Ds_all is larger than the standard value Ds_std (Step S42).

If it is determined, in Step S42, that the data size Ds_all is equal to the standard value Ds_std or less, the series of operations proceeds to Step S12, and the above-described Steps S12-S19 are sequentially executed.

On the other hand, if it is determined, in Step S42, that the data size Ds_all is larger than the standard value Ds_std, the control management module 15A of the control terminal 1A detects the earliest control timing Tcf1 and the latest control timing Tcd1 among the control timings at the sensors 2-5 (Step S44).

Then, the control management module 15A of the control terminal 1A determines the control timings Tcf1-Tcfn including the control timing Tcf1 and its successive timings Tcf2-Tcfn and the control timings Tcd1-Tcdn including the control timing Tcd1 and its successive timings Tcd2-Tcdn to be the transmission timings of the aggregate control commands (Step S45).

Then, the data management module 14A of the control terminal 1A produces a plurality of packets including a plurality of control commands by using the methods described above and broadcasts the produced plurality of packets to the sensors 2-5 at the control timings Tcd1-Tcdn or the control timings Tcf1-Tcfn received from the control management module 15A (Step S46).

After that, the series of operations proceeds to Step S14, and the above-described Steps S14-S19 are sequentially executed.

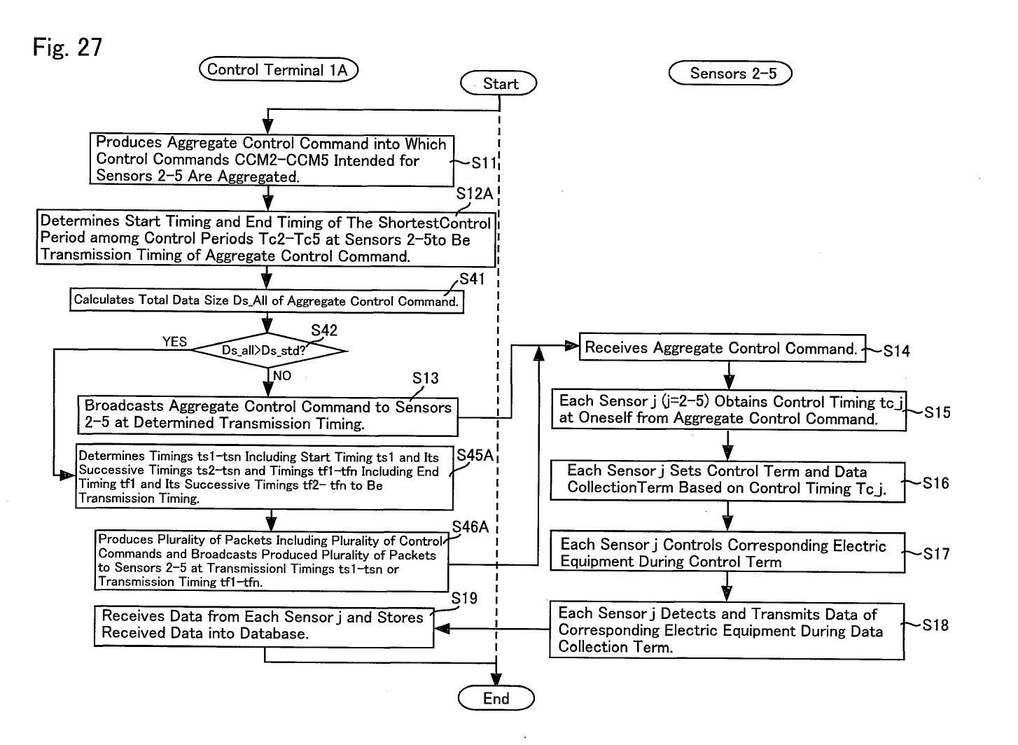

FIG. 27 is a flowchart to explain the operations using the control method MTH2 according to Embodiment 2.

The flowchart shown in FIG. 27 is identical with the flowchart shown in FIG. 13 except that Steps S41, S42, S45A, and S46A are added to the flowchart shown in FIG. 13.

With reference to FIG. 27, after the above-described Step S12A, Steps S41 and S42 described with reference to FIG. 26 are sequentially executed.

If it is determined, in Step S42, that the data size Ds_all is equal to the standard value Ds_std or less, the above-described Steps S13-S19 are sequentially executed.

On the other hand, if it is determined, in Step S42, that the data size Ds_all is larger than the standard value Ds_std, the control management module 15A of the control terminal 1A determines the timings ts1-tsn including the start timing ts1 and its successive timings ts2-tsn and the timings tf1-tfn including the end timing tf1 and its successive timings tf2-tfn to be the transmission timings (Step S45A).

Then, the data management module 14A of the control terminal 1A produces a plurality of packets including a plurality of control commands and broadcasts the produced plurality of packets to the sensors 2-5 at the transmission timings ts1-tsn or the transmission timings tf1-tfn received from the control management module 15A (Step S46A).

After that, the series of operations proceeds to Step S14, and the above-described Steps S14-S19 are sequentially executed.

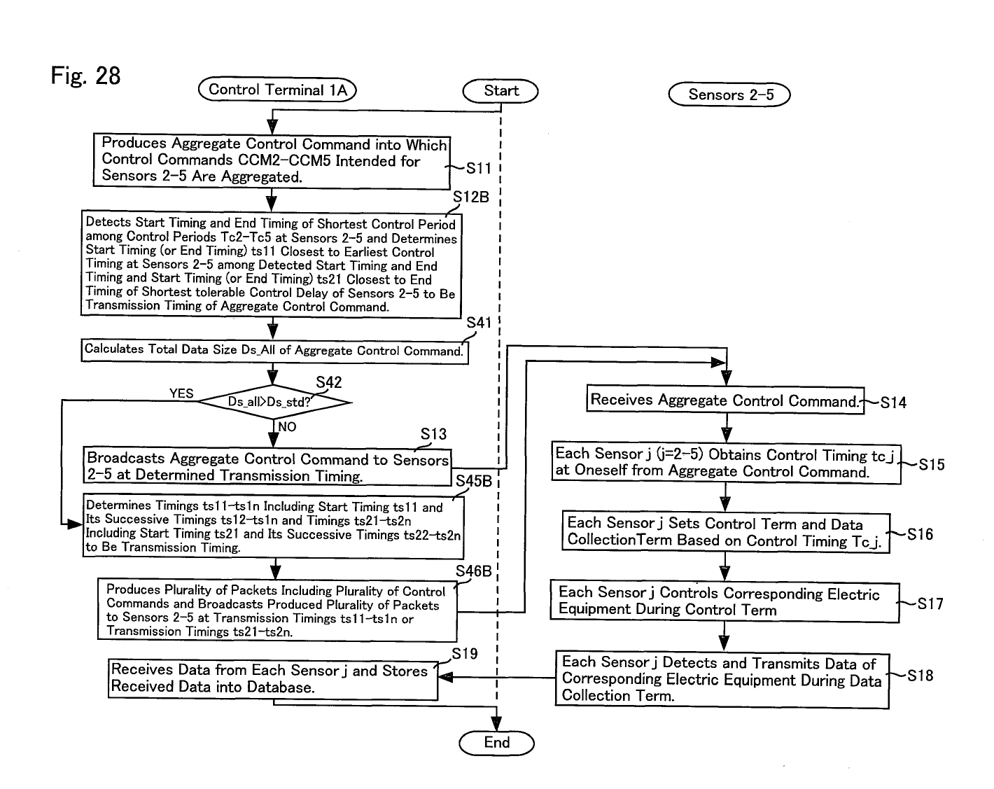

FIG. 28 is a flowchart to explain the operations using the control method MTH3 according to Embodiment 2.

The flowchart shown in FIG. 28 is identical with the flowchart shown in FIG. 14 except that Steps S41, S42, S45B, and S46B are added to the flowchart shown in FIG. 14.

With reference to FIG. 28, after the above-described Step S12B, Steps S41 and S42 described with reference to FIG. 26 are sequentially executed.

If it is determined in Step S42 that the data size Ds_all is equal to the standard value Ds_std or less, the above-described Steps S13-S19 are sequentially executed.

On the other hand, if is determined in Step S42 that the data size Ds_all is larger than the standard value Ds_std, the control management module 15A of the control terminal 1A determines timing ts11-ts1n including the start timing ts11 and its successive timings ts12-ts1n and timing ts21-ts2n including the start timing ts21 and its successive timings ts22-ts2n to be the transmission timings (Step S45B).

Then, the data management module 14A of the control terminal 1A produces a plurality of packets including a plurality of control commands and broadcasts the produced plurality of packets to the sensors 2-5 at the transmission timings ts11-ts1n or the transmission timings ts21-ts2n received from the control management module 15A (Step S46B).

After that, the series of operations proceeds to Step S14, and the above-described Steps S14-S19 are sequentially executed.

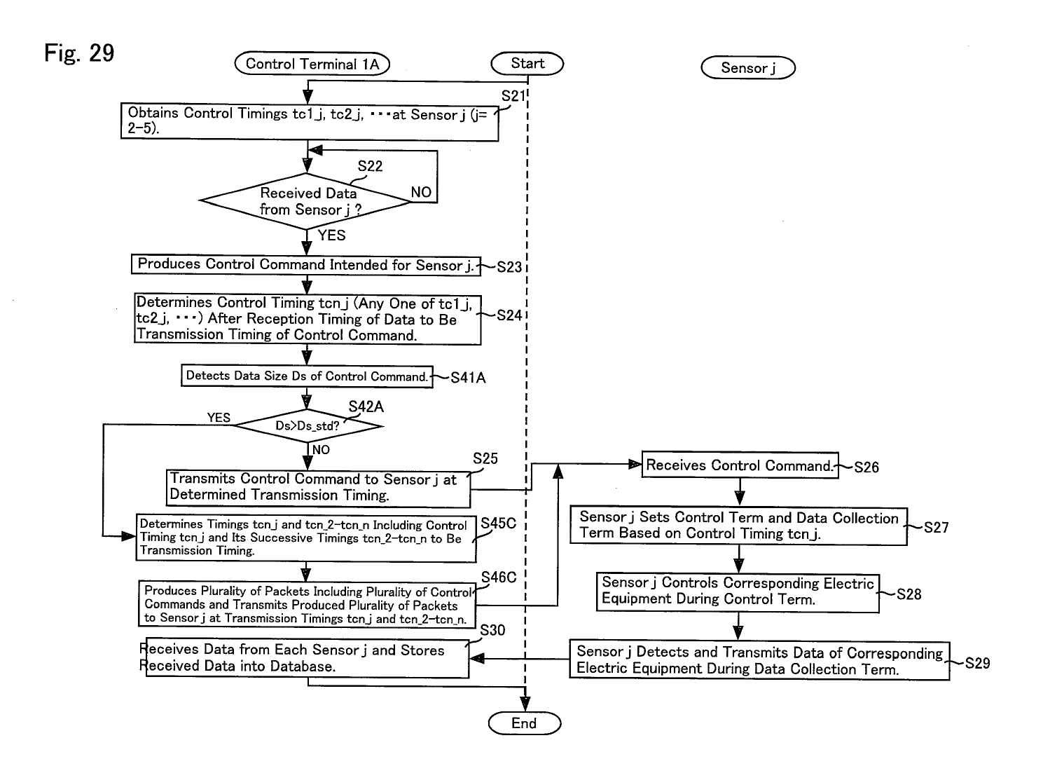

FIG. 29 is a flowchart to explain the operations using the control method MTH4 according to Embodiment 2.

The flowchart shown in FIG. 29 is identical with the flowchart shown in FIG. 15 except that Steps S41A, S42A, S45C, and S46C are added to the flowchart shown in FIG. 15.

With reference to FIG. 29, after the above-described Step S24, the data management module 14A of the control terminal 1A detects the data size Ds of the control command (Step S41A). Then, the data management module 14A determines whether the data size Ds is larger than the standard value Ds_std (Step S42A).

If it is determined in Step S42A that the data size Ds is equal to the standard value Ds_std or less, the above-described Steps S25-S30 are sequentially executed.

On the other hand, if it is determined in Step S42A that the data size Ds is larger than the standard value Ds_std, the control management module 15A of the control terminal 1A determines timings tcn_j and tcn_2-tcn_n including the control timing tcn_j and its successive timings tcn_2-tcn_n to be the transmission timings (Step S45C).

Then, the data management module 14A of the control terminal 1A produces a plurality of packets including a plurality of control commands and transmits the produced plurality of packets to the sensor j at the transmission timings tcn_j and tcn_2-tcn_n received from the control management module 15A (Step S46C).

After that, the series of operations proceeds to Step S26, and the above-described Steps S26-S30 are sequentially executed.

As described above, in Embodiment 2, a control command is included in a packet or a plurality of packets according to the data size of the control command, and is transmitted to the sensors 2-5.

Therefore, even if the data size of a control command increases, the control command is transmitted to the sensors 2-5 with high reliability.

It is described in the above that a control command is transmitted to all of the sensors 2-5, however, Embodiment 2 is not limited to that: A control command may be transmitted to some of the sensors 2-5.

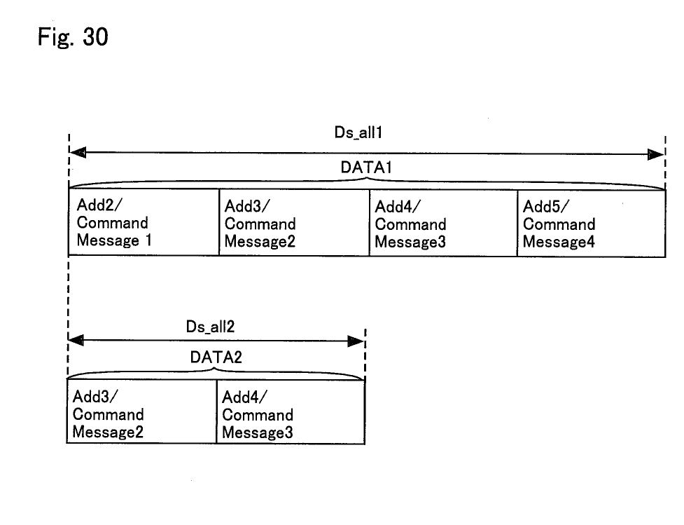

FIG. 30 is a figure to explain another method of producing a plurality of packets including a plurality of control commands.

Assume that a control command is transmitted to the sensors 3 and 4, for example, among the sensors 2-5. With reference to FIG. 30, if no control command is to be transmitted to the sensors 2 and 5, the data management module 14A of the control terminal 1A deletes the field for storing Add2/Command Message 1 and Add5/Command Message 4 from the field for storing data DATA1=[Add2/Command Message 1|Add3/Command Message 2|Add4/Command Message 3|Add5/Command Message 4] to produce a field for storing data DATA2=[Add3/Command Message 2|Add4/Command Message 3]. Then, the data management module 14A stores the data DATA2=[Add3/Command Message 2|Add4/Command Message 3] into the produced field. The data size thereby decreases from a data size Ds_all1 to a data size Ds_all2.

Then, the data management module 14A compares the data size Ds_all2 of the data DATA2 with the standard value Ds_std, and by using the methods described above, and includes the command messages 2 and 3 in a packet or a plurality of packets to transmit to the sensors 3 and 4.

In the same manner, the data management module 14A transmits a control command to some of the sensors 2-5 other than the sensors 3 and 4.

It is described in the above that the standard value Ds_std is 100 bytes, however, Embodiment 2 is not limited to that: The standard value Ds_std may be a value other than 100 bytes.

The embodiments as have been described here are mere examples and should not be interpreted as restrictive. The scope of the present invention is determined by each of the claims, not by the written description of the embodiments, and embraces modifications within the meaning of, and equivalent to, the languages in the claims.

What is claimed is:

1. A sensor network system comprising:
a plurality of sensors provided corresponding to a plurality of electric equipments, the plurality of sensors respectively detecting data representing an operating state of the corresponding electric equipment and respectively controlling the corresponding electric equipment; and
a control terminal transmitting a plurality of control commands at a time to the plurality of sensors through a radio communication, the plurality of control commands being for the plurality of sensors to control the corresponding electric equipment; wherein
each of the plurality of sensors transmits the detected data to the control terminal and controls the corresponding electric equipment at a control timing specified by the control command.

2. The sensor network system according to claim 1, wherein the control terminal determines a transmission timing of the control command based on a plurality of control periods at the plurality of sensors and a plurality of control timings at the plurality of sensors and transmits the control command to the plurality of sensors through a radio communication at the determined transmission timing.

3. The sensor network system according to claim 2, wherein if the plurality of control periods are equal to each other, the control terminal determines the earliest control timing and the latest control timing among the plurality of control timings to be the transmission timing.

4. The sensor network system according to claim 3, wherein the control terminal transmits the plurality of control commands at a time to the plurality of sensors at the earliest control timing or the latest control timing after reception of the data from the plurality of sensors.

5. The sensor network system according to claim 2, wherein if the plurality of control periods are different from each other, the control terminal determines the start timing and the end timing of the shortest control period among the plurality of control periods to be the transmission timing.

6. The sensor network system according to claim 5, wherein the control terminal transmits the plurality of control commands at a time to the plurality of sensors at the start timing or the end timing after reception of the data from the plurality of sensors.

7. The sensor network system according to claim 1, wherein if the total data size of the plurality of control commands is larger than a standard value, the control terminal transmits the plurality of control commands to the plurality of sensors by including the plurality of control commands in a plurality of packets each having a data size equal to or less than the standard value.

8. The sensor network system according to claim 7, wherein if the plurality of control commands includes an unnecessary control command, the control terminal compares the total data size of the rest of the control commands other than the unnecessary control command with the standard value, and if the total data size of the rest of the control commands is larger than the standard value, transmits the rest of the control commands by including the rest of the control commands in the plurality of packets.

9. The sensor network system according to claim 7, wherein the control terminal transmits the number of the plurality of packets by including the number in a packet first to be transmitted among the plurality of packets.

10. A sensor network system comprising:
a plurality of sensors provided corresponding to a plurality of electric equipments, the plurality of sensors respectively detecting data representing an operating state of the corresponding electric equipment and respectively controlling the corresponding electric equipment; and
a control terminal transmitting, to a sensor controlling the electric equipment, a control command for the sensor controlling the electric equipment to control the corresponding electric equipment, upon reception of the data from the sensor controlling the electric equipment; wherein
the sensor controlling the electric equipment controls the corresponding electric equipment at a control timing specified by the control command.

11. The sensor network system according to claim 10, wherein if the data size of the control command is larger than a standard value, the control terminal transmits the control command to the sensor controlling the electric equipment by including the control command in a plurality of packets each having a data size equal to or less than the standard value.
